(19) United States
(12) Patent Application Publication
(10) Pub. No.: US 2005/0216240 A1
(43) Pub. Date: Sep. 29, 2005

(54) Design method for belt transmission system

(75) Inventors: Tsutomu Shiga, Nukata-gun (JP); Atsushi Umeda, Okazaki-city (JP); Kouichi Ihata, Okazaki-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/083,946

(22) Filed: Mar. 21, 2005

(30) Foreign Application Priority Data
Mar. 26, 2004 (JP) 2004-090884

(51) Int. Cl. G06F 17/10

(52) U.S. Cl. 703/2; 703/1

(57) ABSTRACT

In a design method for a belt transmission system, tensile forces between pulleys are calculated from a total layout of the belt transmission system, such as a spring constant of a belt, a distance between the pulleys, an initial tensile force, a driving force for the respective pulleys to be calculated from a load of the respective pulleys, and so on. A coefficient of static friction is calculated from the tensile forces at the pulling and un-pulling sides and a contact angle. Then the coefficient of the static friction is compared with a maximum coefficient of the static friction, and it is determined that no slip occurs when the coefficient of the static friction is smaller than the maximum coefficient of the static friction.

### CROSS REFERENCE TO RELATED APPLICATION

This application is based on Japanese Patent Application No. 2004-90884 filed on Mar. 26, 2004, the disclosure of which is incorporated herein by reference.

### FIELD OF THE INVENTION

The present invention relates to a design method for a belt transmission system, in which driving force is transmitted by use of frictional force of a belt, a rope or the like. In particular, the present invention relates a design method for a belt transmission system of, so called, a serpentine type for a motor vehicle, in which multiple pulleys are driven by a belt.

### BACKGROUND OF THE INVENTION

Two design points should be taken into consideration when designing a belt transmission system, in which a driving force is transmitted by use of frictional force of a belt or the like. The first design point is a degree of force applied to the belt during the transmission operation, and the second design point is a degree of force which can be surely transmitted without causing a slip between the belt and pulleys.

As known in the art, the above two design points are calculated according to Euler's theory. A general idea of the Euler's theory is described with reference to FIG. 1, which is a model drawing showing a relation between a pulley 100 and a belt 200. In FIG. 1, “T₁” is a tensile force at an un-pulling side, “T₂” is a tensile force at a pulling side, and “φ” is a contact angle. An equilibrium equation is derived at an equilibrium position having a micro belt length “dₛ” (a micro contact angle is “dψ”). When the equation is integrated from a starting point “m” to an ending point “n”, a mathematical formula (7) indicated below is obtained. In FIG. 1, “t” is a tensile force applied to the belt at this point, “Q_{ds}” is a normal force, “μQ_{ds}” is a frictional force, “F_{ds}” is a centrifugal force, “μ” is a coefficient of static friction.

“T′₁” and “T′₂”, which are values when a slip is just about to occur, are represented as the formula (7). In the formula (7), ”μₘₐₓ” is a maximum coefficient of static friction, “w” is a weight of the belt of a unit length, “v” is a speed, and “g” is gravity.
Formula (7):

$$\frac{{T}_{2}^{′} - \frac{{wv}^{2}}{g}}{{T}_{1}^{′} - \frac{{wv}^{2}}{g}} = {ⅇ}^{{μ }_{max} ϕ} \qquad ( 7 )$$

When a driving force is represented as “P”, a mathematical formula (8) is obtained. The driving force “P” is a force for driving the belt by the pulley in case of a driving pulley, whereas it is a force to be applied from the belt to the pulley in case of a driven pulley.

Mathematical formulas (9) and (10) can be obtained from the formulas (7) and (8).

The mathematical formulas (9) and (10) represent a condition of the transmission, in which the slip is just about to start. When those formulas (9) and (10) are modified to represent such a condition of the transmission, in which the transmission is performed without the slip, mathematical formulas (11) and (12) can be obtained, wherein a pulley angle (the contact angle), at which a power transmission is actually performed, is assumed to be at a value of “φ₀” (“φ₀”<“φ”). As a result, the condition of the transmission, in which the transmission is performed without the slip, could be represented, according to Euler's theory.

Formula (8):
P=T′₂−T′₁ (8)
Formula (9):

$${T}_{1}^{′} = \frac{P}{{ⅇ}^{{μ }_{max} ϕ} - 1} + \frac{{wv}^{2}}{g} \qquad ( 9 )$$

Formula (10):

$${T}_{2}^{′} = \frac{{ⅇ}^{{μ }_{max} ϕ} P}{{ⅇ}^{{μ }_{max} ϕ} - 1} + \frac{{wv}^{2}}{g} \qquad ( 10 )$$

Formula (11):

$${T}_{1} = \frac{P}{{ⅇ}^{{μ }_{max} {ϕ}_{0}} - 1} + \frac{{wv}^{2}}{g} \qquad ( 11 )$$

Formula (12):

$${T}_{2} = \frac{{ⅇ}^{{μ }_{max} {ϕ}_{0}} P}{{ⅇ}^{{μ }_{max} {ϕ}_{0}} - 1} + \frac{{wv}^{2}}{g} \qquad ( 12 )$$

More specifically, such a model as is shown in FIG. 2 is considered. In FIG. 2, two pulleys (a driving pulley 101 and a driven pulley 102) are shown, and a belt 200 is hung between the pulleys. An angle “φ₀” (called as a creep angle), at which a power transmission is actually performed, is smaller than geometrical contact angles “φ₁” and “φ₂”, and difference angles of (φ₁−φ₀) and (φ₂−φ₀) are assumed as such an angle as “a resting angle”, at which the tensile force is not increased or decreased.

When a calculation is performed according to the above concept, a smaller amount among “φ₁” and “φ₂” is substituted for the angle “φ₀”, because the angle of “φ₀” is unknown. As a result, a difference between an original angle “φ₀” and the substituted angle “φ₁” or “φ₂” is a marginal amount. The amounts of “T₁” and “T₂” are calculated from the formulas (11) and (12) and then a minimum initial tensile force “T₀” is given by a formula (13).
Formula (13):

$${T}_{0} = \frac{{T}_{1} + {T}_{2}}{2} \qquad ( 13 )$$

FIG. 3 shows a further model having three pulleys, wherein a single belt 200 is hung among the driving pulley 101, the driven pulley 102, and another driven pulley 103. “T₁”, “T₂” and “T₃” are respectively tensile forces applied to the belt, whereas “P₁”, “P₂” and “P₃” are driving forces. In the model shown in FIG. 3, a relation of “P₁=P₂+P₃” is realized. In the model in FIG. 3, since the driving force “P₁” of the driving pulley is a sum of the driving forces (“P₂+P₃”) of two driven pulleys, the belt at the driving pulley deems to be most likely to slip among three pulleys. Therefore, the amounts of “T₁” and “T₂” are calculated from the formulas (11) and (12), wherein “φ₁” is substituted for “φ₀”. Further, a relation of “T₃=T₂−P₂” is realized.

It is, however, necessary to confirm by the following formulas (14) and (15) that the slip is not actually occurring at the respective driven pulleys. The formulas (14) and (15) are modified from the formula (7).

In the case that the driven pulley has a margin in its contact angle when it is driven, the contact angle “φ” does not exceed “φ₀”. That is, the values in both sides of the formula (7) do not come to equal to each other, and therefore, the following formulas (14) and (15) of inequality must be realized, wherein the section of the centrifugal force is neglected.
Formula (14):

$$\frac{{T}_{2}}{{T}_{3}} \leq {ⅇ}^{{μ }_{max} {ϕ}_{2}} \qquad ( 14 )$$

Formula (15):

$$\frac{{T}_{3}}{{T}_{1}} \leq {ⅇ}^{{μ }_{max} {ϕ}_{3}} \qquad ( 15 )$$

In the case that the above formulas are not satisfied, the driving pulley and the driven pulleys are counterchanged in the formulas to check it again. If the above formulas were not satisfied, either, even with such counterchanges, the check is repeated by further counterchanging the pulleys. If such checking process is repeated by at least three times, at least one of the cases must meet the above formulas.

In the belt transmission system of the serpentine type, the above checking processes are necessarily repeated by such times, corresponding to the numbers of the pulleys. The more the number of pulley is increased, the more the combination of the pulleys is increased. When a sufficient time can be used, it can be confirmed whether any slip is actually occurring or not at each of the pulleys according to the above formulas, by substituting the driving forces “P₁”, “P₂”, “P₃” . . . into the formulas.

The degree of force applied to the belt during the transmission operation, which is also one of the two design points, has not yet been decided. The values of “T₁”, “T₂”, “T₃” . . . can not be obtained in the above formulas, since the value of φ₀” is unknown.

If the smaller angle among φ₁” and φ₂” is substituted for the angle of “φ₀”, as in the same manner of determining whether the slip is occurring or not, the value of “T₁” calculated from the formula (11) would be estimated as such a value smaller than an actual value. (The value “T₂” would be likewise estimated as a smaller value.) Those values are underestimated in view of a breakage of the belt. Furthermore, the formulas (11) and (12) represent the condition, in which the slip is just about to occur. Therefore, those formulas can not be applied to such a situation, in which the pulleys and the belt are adjusted by an initial tensile force of “T₀” calculated from the formula (13) defined by the driving force “P”, and in which a partial load (for example, a half of “P”) is actually applied to the belt.

FIG. 4A is experimental results made by the inventors showing tensile forces actually measured, which are compared with the values of “T₁” and “T₂” calculated by the Euler's formulas. In the experiments, the driving pulley 101 and the driven pulley 102, each having the dimensions shown in FIG. 4B, were used, and a V-ribbed belt having four grooves was used as the belt 200. In the experiments, a load is applied to the driven pulley in the condition that the driven pulley is stopped, and driving torque for the driving pulley was measured by a torque wrench. The tensile force is measured by a contact-less measuring device, which measures resonant frequency by a microphone. The measured “μₘₐₓ” was 0.92. The initial tensile force is decided as “300N” from the formula (13) so that any slip does not occur, under the assumption that the maximum driving force “P” is “510N”. And two pulleys are arranged at a distance. The values of “T₁” and “T₂” are calculated from the Euler's formulas (11) and (12), and decided as “T₁40N” and “T₂=550N”, wherein “φ₁=167°” is substituted for “φ₀”.

Then, the driving force “P” was varied, and the tensile forces were measured. For example, at the driving force of “P=210N”, the measured values were respectively “T₁=190N” and “T₂=400N”, which are larger by about “200N” than the values calculated from the Euler's formulas.

As mentioned above, the tensile force to be calculated (or estimated) from the Euler's formulas is limited to the values obtained in the situation that the certain initial tensile force is applied to the belt and the maximum driving force is applied to the belt. And in the case that the partial load (partial driving force) is applied, the Euler's formulas can not be used. This is, however, quite natural because the Euler's formulas are so made to satisfy only the worst condition. The tensile forces at the partial load seem to be plotted on lines of the following formulas (16) and (17), which can be obtained from the formulas (8) and (13).
Formula (16):

$${T}_{1} = {T}_{0} - \frac{P}{2} \qquad ( 16 )$$

Formula (17)

$${T}_{2} = {T}_{0} + \frac{P}{2} \qquad ( 17 )$$

It is to be understood, without confirming the above result, that it is impossible to calculate the tensile forces of the belt at the partial load operation from the Euler's formulas. This is because the initial tensile force “T₀” is set to be a certain value, independently of the loads during the driving operation. It is, of course, necessary to determine whether any slip may occur or not during the driving operation with the initial tensile force of “T₀”. The slip may occur only after the driving operation has started, however, the setting is made before starting the operation. Accordingly, the measured values are automatically plotted on the lines of the formulas (16) and (17).

This is also true in the case that the belt driving system is provided with an auto-tensioning pulley, which is often used in the belt driving system of the serpentine type. For example, when the auto-tensioning pulley is provided at an un-pulling side (T₁) of the belt arrangement shown in FIG. 4B, the tensile force (T₁) of the belt at this un-pulling side is fixed to such a value decided by the auto-tensioning device. As a result, “T₁=a load of the auto-tensioning device” is realized, and then the value of “T₂” is obtained from “T₂=T₁+P”. Even in this case, the tensile forces are obtained from the formulas, which are nothing to do with the Euler's formulas. And those formulas actually meet the values of the driving operation in various loads.

As above, it has been a problem in that the tensile force, which is one of the important design points for designing the belt transmission system, can not be estimated from the Euler's formulas. The Euler's formulas are still used for estimating the tensile forces during the belt driving operation, in some cases, in spite of knowing the above problem. However, such estimated values are meaningless, when the load “P” is varied.

The Euler's method is not practical, either, for the second important design point, namely, for estimating the degree of force to be surely transmitted without causing the slip between the belt and pulleys. According to the Euler's method, such a worst point (pulley) at which a slip may happen to occur is at first found out, when the driving force is fixed. Then at the second worst point (pulley), it is confirmed whether the following formula (18) is satisfied or not, to verify that the above worst point is correct. In the case of the belt transmission system of the serpentine type, however, the number of pulleys is too much to repeat the above calculation.
Formula (18):

$$\frac{Tensile Force at Pulling Side }{Tensile Force at Un \text{-} Pulling Side} \leq {ⅇ}^{{μ}_{max} ϕ } \qquad ( 18 )$$

Furthermore, as described above, since the tensile force itself can not be decided, the left side of the formula (18) can not be calculated. Since there is no other alternative, the values of “T₁” and “T₂” for the driving pulley are calculated from the formulas (11) and (12) (with the contact angle of the driving pulley), and those calculated values are substituted in the formula (18), to determine whether the slip may occur or not at the driven pulley. Since this method is extremely unclear and unfixed, the following formulas have been used according to experiences in belt manufacturers. Namely, the values obtained from the following formulas (19) and (20) for the respective pulleys are set to be smaller than predetermined values.

Formula (19):
Ratio of driving force “P” to contact angle “φ”=P/φ (19)
Formula (20):

$$Ratio of driving force '' P '' to contact length '' ϕ \cdot Pulley radius '' = P / ( ϕ \cdot Pulley radius ) \qquad ( 20 )$$

According to this method, an acceptable value is in advance decided for one belt (having one rib), and then a necessary number of belts, with which the slip may not occur, is decided. Even in such a method, physical basis for those values obtained in the above method is unclear, and the initial tensile force is not considered in the above formulas (19) and (20). And therefore, this method is not practical, either.

It is an actual situation, as above, that there is no practically available designing method, which can meet two important design points (estimation of tensile forces and slip determination). One of the reasons of this situation is in that the initial tensile force has not been significantly taken into consideration. According to the prior art documents, it is a general concept that the slip may not occur if the initial tensile force “T₀” is set to be a value larger than the value obtained from the flowing formula (21), wherein “T₁” and “T₂” are calculated from Euler's formulas.
Formula (21):

$${T}_{0} = \frac{{T}_{1} + {T}_{2}}{2} \qquad ( 21 )$$

Namely, the minimum tensile force for transmitting a predetermined driving force is defined as the initial tensile force “T₀”. The initial tensile force “T₀” is, therefore, varied depending on the rotational speeds and the load conditions (i.e. the full load, or the partial load). The initial tensile force is set to be a value, which is the maximum amount among the various initial tensile forces respectively calculated for all of the operating conditions (the rotational speeds and the load conditions). It is, however, very much strange, because the above concept does not give answers to the questions, how the tensile force during the operation of transmitting the driving force can be obtained, if the initial tensile force is set to the necessary value or if the initial tensile is set to the value other than the necessary value. What is a problem here among others, is that even the necessary minimum tensile force can not be obtained, because the values of “T₁” and “T₂” can not be decided. It is quite a strange that the slip is determined whether it occurs or does not occur, based on the tensile forces which can not be decided and the creep angle “φ₀” which can not be obtained.

Furthermore, in some cases for the purpose of taking the measures to meet the above situation, such a value as is different from an actual value is substituted for the coefficient of static friction. For example, a value of around 0.5 is substituted in spite that an actually measured value of “μₘₐₓ” is around 1.0. And the values so obtained are used for corrections of the contact angle, and so on. This is, however, nothing but “putting the cart before the horse”.

There are other alternatives proposed. However, since those alternatives are basically starting from the Euler's theory, they are much alike to the above described conventional methods. Although the design of the friction drive, such as the belt transmission, is old technology, its scientific basis is very much unclear.

There seem to be two reasons, why there is a mistake in the above described conventional design method. One of them is that the Euler's formulas can not estimate, how much margin the belt transmission system has in a condition that a driving force is being transmitted without slips, since the Euler's formulas should be fundamentally used to measure the maximum coefficient of static friction of a rope or the like which moves on a cylindrical surface.

The second reason seems to be coming from a mistake regarding an external force and internal force, or a mistake regarding what is unknown. An explanation is made, for a better and easier understanding, in relation to an equilibration of a body, which has a weight of “W” and is put on an inclined plane. A model of such equilibration is shown in FIG. 5. Before the body W starts with its slide, “Q=W·Cos α” in FIG. 5. A frictional force in the condition that there is no slip, is “frictional force=μQ=μW·Cos α”. In this formula, the coefficient of the friction “μ” is unknown. However, when the angle of inclination is increased so that the body starts its sliding off, the coefficient of the friction just before the sliding off of the body can be measured. Namely, the maximum coefficient of the static friction is a known value. When this value is substituted as “μₘₐₓ” in the above formula, the formula becomes “the frictional force in the condition of no slide=μW·Cos α=μₘₐₓ W·Cos α₀”, wherein “α₀” is an angle which is actually affecting the friction (called as “a pseudo-angle of friction”, “α₀”<“60 ”).

Although this is not wrong, it is not adequate, either. The coefficient of the static friction “μ” is calculated as “μ=tan α”, although the value of “μ” is unknown. When this value “μ=tan α” is inserted into the above formula, it becomes “the frictional force in the condition of no slide=μW·Cos α=W·Sin α”. The frictional force at the angle “α” of inclination is decided without using “the pseudo-angle of friction α₀”. This kind of way of solving is apparently not correct. However, the analyzing method using the Euler's formulas is done in the similar way to this sample. In the solving method using the Euler's formulas, a concept of the creep angle “φ₀” is introduced.

A simple and scientific determination of the slip must have been possible under normal conditions, according to which it could be determined that the slip occurs when the value “μ” exceeds “μₘₐₓ”, if the frictional force in the condition of no slide (in the normal transmitting condition without slip) could be correctly calculated, and the coefficient of static friction was obtained.

Nevertheless, it has been attempted in the conventional method to determine the slip of the belt, by using the Euler's formulas. The reason why the determination of the belt slip can not be correctly done in the conventional method is in the fact that it has been attempted to obtain the tensile forces “T₁” and “T₂” from the Euler's formulas.

FIG. 6 shows a model of the belt transmission, wherein a micro portion of the belt is shown to compare with the model shown in FIG. 5. In FIG. 6, unknown values are a normal component of force “Q”, a component of force “μQ” in a tangential line, and a tensile force “T₂” of a pulling side. A tensile force “T₁” of an un-pulling side can be actually regarded as the unknown value identical to the tensile force of “T₂”, because the tensile force “T₁” can be obtained as “T₁=T₂−P” from a driving force “P” and the tensile force “T₂”, as shown in FIG. 6. Since there are three unknown values but only two equilibrium equations can be obtained, the equations can not be solved. The above two equilibrium equations are equations of equilibrations in a radial direction and a circumferential direction. Since there is no other alternative, the value of “μ” is regarded as the known value to reduce the unknown values by one, wherein “μ” is substituted by the maximum coefficient of the static friction “μₘₐₓ”, so that the equations can be solved.

The above way of solving the equations is not correct, either. In truth, the tensile force “T₂” of the pulling side should have been a known value, whereas the coefficient of friction “μ” should have been an unknown value. This is because that the tensile forces “T₁” and “T₂” are actually decided by an initial tensile force “T₀” freely set up by a user or a load applied by a belt tensioning device.

It is necessary to differentiate the external force from the internal force of the body, in case of solving the equilibration. In the model shown in FIG. 6, the forces “Q” and “μQ” at the contacting portion between the pulley and the belt are the internal forces. The tensile forces “T₁” and “T₂” are the external forces to be calculated from the. equilibrium equations, wherein various relations to the external conditions must be taken into consideration. Namely, the tensile forces should be decided by taking the other pulley into consideration. The external forces must have been decided before the internal forces are to be solved. It is a general practice to use the external forces as the initial conditions for the purpose of solving the internal forces.

Nevertheless, since in the above model, the external forces are decided by taking only the single pulley into consideration when solving the internal forces, the values thus obtained may not make sense in relation to the other pulley. As a result, the “hypothetical” creep angle “φ₀” has been created to make sense in relation to the other pulley. However, this process has simply resulted in confusion. The value “μ”, which should be obtained through the calculation, has been substituted by the value “μₘₐₓ”, which is known without making the calculation, whereas the known value “φ” is substituted by the hypothetical value “φ₀”. However, since even the value “φ₀” can not be obtained, the known value “φ₀” is used again. Furthermore, the value “μₘₐₓ” is substituted by another value, in spite that it is the known value. Thus, the above method falls in a vicious cycle.

As above, the conventional method has drawbacks, in which it has been attempted to solve the problems for the belt transmission system, without differentiating the known values and unknown values, and the external forces and the internal forces, namely the causes and the effects. The conventional method could have overcome the contradiction in the case that the belt transmission system has two pulleys and the system is operated with a constant load. However, the conventional design method can not solve the problems in the belt transmission system of the serpentine type, or in the belt transmission in which the load is varied.

As already described, in the conventional design method, the determination of the slip must be repeatedly done, as shown in FIG. 7, and the maximum tensile forces at the maximum load can be only calculated. It is a general tendency in recent years that the belt transmission system of the serpentine type is used for an internal combustion engine. Auxiliary machines (accessories) are operated at its full or partial load. And since the driving force is generated by the engine, its rotational speed varies. Under the above situations, the driving force to the driven pulleys continually varies, and thereby the pulley, at which the slip may possibly occur, is changed at all times. If the determination of the slip were done by the process shown in FIG. 7, the number of determination process would become to an astronomical number. Even if it could be done, the determination should be done under the condition of the maximum load. To the end, the design having a large safety ratio can not be actually avoided. The tensile forces during the actual operation, which can be estimated from the Euler's theory, are the tensile forces only at one driving force among the whole range of driving forces, as shown in FIG. 4A.

In recent years, many auxiliary machines (accessories) are driven by an internal combustion engine by a belt transmission system of the serpentine type using V ribbed belt or by the belt transmission system in which an auto-tensioning device is provided to ensure a necessary tensile force during belt transmitting operation. And multiple pulleys, seven or eight pulleys, are driven by one belt. In such a belt transmission system, however, there are some problems in that the auto-tensioning device may be largely swung due to variations of the tensile forces during the operation, the belt may be sympathetically vibrated (the resonance frequency is varied depending on the tensile forces), or the belt may be stringed out beyond its elastic limit. It has become more important to exactly grasp the conditions of the belt operation. However, as mentioned above, it is the reality that there is no satisfactory design method for a belt transmission system, even for the system having only two pulleys.

### SUMMARY OF THE INVENTION

It is, therefore, an object of the present invention, in view of the above mentioned problems, to provide a design method for a belt transmission device, according to which the design of the belt transmission system can be easily and exactly achieved.

The inventors went back to the basics for the friction drive, to achieve the above object. The inventors considered whether the tensile forces can not be obtained unless the integration equation for the micro point, like the Euler's theory, should be solved. In the conventional method, the formula (7) for the integration has caused the contradiction in all of the post-process. The present inventors came to the conclusion, as described above, that the external force and the internal force have been erroneously handled. And the inventors have finally conceived a new method, in which the problem for the belt drive can be solved in a way different from (opposite to) the conventional method. Namely, the tensile forces among the pulleys are macroscopically figured out, and then the detailed tensile forces of the respective pulleys are calculated based on such macroscopic values.

According to a first feature of the present invention, which can be applied to a design method for a belt transmission system in which multiple pulleys are driven by a single belt, the tensile forces among pulleys are at first calculated from the total layout for the pulley, the belt and loads, wherein the total layout includes a spring constant of the belt, a length of a belt span, an initial tensile force, and driving forces calculated from the loads of the respective pulleys. The coefficient of static friction for the respective pulleys is calculated from a tensile force of a pulling side, a tensile force of an un-pulling side and a contact angle, which have been obtained according to the above calculation from the total layout. Then, the above coefficient of static friction is compared with the maximum coefficient of static friction between the belt and the pulley, and it is determined that no slip occurs in the pulley, when an inequality of “the coefficient of static friction<μₘₐₓ” is satisfied.

According to the above feature, the respective tensile forces among the pulleys are at first decided. This process is called as the first step. Then, the coefficient of static friction for the respective pulleys is calculated based on the results of the first step. This process is called as the second step. And finally the determination of the slip is done. This process is called as the third step. Since the tensile forces are macroscopically decided from the total pulley layout (for all of the pulleys) at the first step, any contradiction does not appear at the respective pulleys. Further, since the slip determination for each pulley is carried out based on the coefficient of static friction having physical basis, the method of the invention is scientific. The slip problem for the respective pulleys can be solved by changing design parameters of the individual pulley, and does not require the change of the other pulleys. Accordingly, the calculation for the design is not necessary to be repeated.

According to a second feature of the present invention, the coefficient “η” of the static friction in the design method of the above first feature is calculated by the following formulas (22) and (23), wherein “w” is a weight of the belt for a unit length, “v” is a speed of the belt, and “g” is an acceleration of gravity.
Formula (22):

$$η = \frac{1}{Contact Angle θ} ln \frac{( Tensile Force at Pulling Side - \frac{{wv}^{2}}{g} ) }{( Tensile Force at Un \text{-} Pulling Side - \frac{{wv}^{2}}{g} )} \qquad ( 22 )$$

Formula (23):

$$η = \frac{1}{Contact Angle θ} ln \frac{( Tensile Force at Pulling Side ) }{( Tensile Force at Un \text{-} Pulling Side )} \qquad ( 23 )$$

According to the above second feature of the invention, the coefficient “η” of the static friction can be obtained from the tensile force “T” macroscopically decided and the geometrical contact angle “θ”. The above method does not require an imaginary creep angle, the value of which can not be decided as described earlier. Further, the method of the present invention can be applied to the design of the belt transmission system, which can be operated with a partial load.

According to a third feature of the present invention, the design method of the above first or second feature is applied to the design of the belt transmission system of the serpentine type, in which an internal combustion engine is operated as a driving source of the belt transmission system.

According to the above third feature, since the design method of the present invention is applied to the complex belt transmission system of the serpentine type, a large number of slip determination processes is not necessary. For example several number of slip determination processes is enough to obtain the calculation results, whereas a statistically increasing number of the slip determination processes was necessary in the conventional design method.

According to a fourth feature of the present invention, the design method of the above third feature includes the design of an idler pulley and a belt tensioning pulley.

According to the above fourth feature, the calculation can be simplified, since the design of the idler pulley and the belt tensioning pulley, which do not require the driving force, can be done in the same manner to the design of the other pulleys for which the load is applied, namely which require the driving force. The driving force for those pulleys can be regarded as “0”, and thereby those pulleys can be handled in the same manner to the other pulleys. Accordingly, the calculation formulas are the same, even when the number of the idler pulley and the belt tensioning pulley is increased.

According to a fifth feature of the present invention, it is determined in the design method having one of the above first to fourth features that the belt would not be separated (lifted up) from the pulley, if the following inequality of the formula (24) is satisfied.
Formula (24):

$$Tensile Force at Un \text{-} Pulling Side > \frac{{wv}^{2}}{g} \qquad ( 24 )$$

Since the tensile forces at the partial load operation can be also correctly calculated, according to the above fifth feature, the determination of high speed, at which the belt can be operated in the normal condition (without slip), can be done by use of the simple inequality. Namely, in the formula (24), the tensile forces at the respective points are simply compared with a value of section having a centrifugal force.

According to a sixth feature of the present invention, it is determined in the design method having one of the above first to fifth features that the belt transmission is securely performed, if the following inequalities of the formulas (25) and (26) are satisfied, wherein the tensile forces among the pulleys respectively calculated are designated by “T₁, T₂, . . . T_{N}”

Formula (25):
T₁, T₂ . . . T_{N}<allowable tensile force of the belt (25)
Formula (26):
T₁, T₂ . . . T_{N}>minimum necessary tensile force of the belt (26)

According to the sixth feature of the invention, since the correct tensile forces can be obtained, such tensile forces can be easily compared with the allowable maximum or minimum values which are decided from material of the belt, or the like.

According to a seventh feature of the present invention for the design method having one of the above first to sixth features, parameters for the pulley layout, such as the contact angle, a pulley diameter, the initial tensile force, a load by the belt tensioning pulley and so on, can be changed to the extent that all of the above given inequalities are satisfied.

According to the above seventh feature, since the design process goes from the macroscopic points to the respective microscopic points, the design from the total to the partial points can be easily done in response to various necessary conditions, without forcing the change to the other pulleys.

According to an eighth feature of the present invention for the design method having one of the above first to seventh features, a resonant frequency “f” of the belt during its operation is calculated from the tensile forces obtained according to the above mentioned design method, and the parameters of the pulley layout (including the contact angle, the pulley diameter, the initial tensile force, the load by the belt tensioning pulley, etc.) are designed in such a manner that the resonant frequency “f” does not coincide with a frequency of an oscillation caused by the driving source or a natural frequency of the load.

According to the above eight feature of the invention, the design of the belt transmission system can be easily and surely done, since the tensile forces in various operating (load) conditions can be correctly obtained and thereby the resonance of the system can be avoided.

According to a ninth feature of the present invention for the design method having one of the above first to seventh features, the load for the pulley, which varies in accordance with passage of time, among the loads for the respective pulleys, is treated as a driving force, and the design process is performed for the respective belt conditions depending on the passage of time, to determine whether any slip may not occur.

According to the above ninth feature of the invention, since the above calculation and determination are simple, the calculation formulas for the transient state will not become complex, and thereby a simulation for the changes in the passage of time becomes possible.

According to a tenth feature of the present invention for the design method having the above ninth feature, the movement of the belt tensioning pulley is calculated for the respective passages of time.

According to the above tenth feature of the invention, since the movement of the belt tensioning pulley can be estimated, investigation for the stress calculation of a tensioning spring, and the like can be easily done.

### BRIEF DESCRIPTION OF THE DRAWINGS

The above and other objects, features and advantages of the present invention will become more apparent from the following detailed description made with reference to the accompanying drawings. In the drawings:

FIG. 1 is a model drawing showing forces between a pulley and a belt in case of Euler's analysis known in the art;

FIG. 2 is a model drawing showing a distribution of tensile forces applied to a belt between two pulleys, according to a conventional understanding;

FIG. 3 is a model drawing showing a distribution of forces in a belt transmission system having three pulleys;

FIG. 4A is a graph showing a relation between tensile forces calculated from the conventionally known Euler's formulas and actually measured values;

FIG. 4B is a model drawing showing dimensions of pulleys;

FIG. 5 is a model drawing showing forces applied to a body staying on an inclined plane by a frictional force;

FIG. 6 is a model drawing showing a portion of a belt to be used in the Euler's analysis;

FIG. 7 is a flow chart showing a process of designing friction transmission system known in the art;

FIG. 8 is a model drawing showing a condition of dimensions and forces in a belt transmission system of a serpentine type;

FIG. 9 is a model drawing showing a behavior of a belt tensioning pulley used in the system shown in FIG. 8;

FIG. 10 is a model drawing a condition of forces between the belt and the pulley, wherein the present invention is applied to a driving pulley;

FIG. 11 is a model drawing a condition of forces between the belt and the pulley, wherein the present invention is applied to a driven pulley;

FIG. 12 is a flow chart showing a process of designing friction transmission system according to the present invention;

FIG. 13 is a model drawing a condition of forces between the belt and the pulley, for the purpose of analyzing a slip which occurs at the driven pulley, to which the present invention is applied;

FIG. 14A is a model drawing showing a measuring method for the maximum coefficient of static friction in a V-ribbed-belt;

FIG. 14B is a graph showing the values obtained from the measurement;

FIGS. 15A to 15D are graphs showing the calculated values obtained by the present invention and actually measured values, wherein both values are compared;

FIG. 16 is a graph showing actually measured values and values given by determination formulas to which the present invention is applied, wherein both values are compared;

FIG. 17 is a model drawing showing an embodiment of a belt transmission system to which the present invention is applied;

FIG. 18 is a graph showing conditions of loads at the respective pulleys in FIG. 17;

FIG. 19 is a graph showing tensile forces in FIG. 17;

FIG. 20 is a graph showing results of calculation, to which the present invention is applied and in which it is determined whether the slip of the belt occurs at the respective pulleys in FIG. 17;

FIG. 21 is a graph showing tensile forces of the driving pulley in the case that the driving pulley in FIG. 17 has an angular acceleration;

FIG. 22 is a graph showing results of calculation for displacement amounts of the belt tensioning pulley in case of FIG. 21; and

FIG. 23 is a graph showing determination results whether the slip of the driving pulley of FIG. 21 occurs or not.

### DETAILED DESCRIPTION OF THE PREFERRED EMBODIMENTS

The present invention is explained with reference to a belt transmission system having a layout of pulleys, as shown in FIG. 8. As shown in FIG. 8, the following analysis is made with reference to the belt transmission system of the serpentine type, having “N” number of pulleys including an idler pulley having no load and an auto-tensioning pulley. The idler pulley is used just for changing a direction of the belt. The auto-tensioning pulley is arranged to move in parallel, and a load is applied to the auto-tensioning pulley by a spring or the like in a parallel moving direction, in order to apply a predetermined tensile force to the belt. The analysis of the present invention can be, needless to say, applied to the belt transmission system having two pulleys, wherein the system has no idler pulley and auto-tensioning pulley. In FIG. 8, the belt transmission system has a driving pulley 101, a driven pulley 102, a driven pulley 103, . . . a driven pulley “n”, . . . and a driven pulley “N”. A belt 200 is hung on all of the pulleys. The driven pulleys include the idler pulley and the auto-tensioning pulley. The total number of the pulleys is “N”. A parameter for the “n”-th pulley is indicated by an identifier “n”. The pulleys further include such a pulley for transmitting a driving force by use of a back surface of the belt. A diameter of the “n”-th pulley is indicated by “Dₙ”, a contact angle between the “n”-th pulley and the belt is indicated by “θₙ”, a driving force is indicated by “Pₙ”, a distance and a tensile force between the “n-1”-th pulley and the “n”-th pulley are respectively indicated by “Lₙ” and “Tₙ”.

A drive for the respective pulleys is performed by a difference of tensile forces before and after the pulley. Accordingly, for the driving pulley 101, a formula of “T₂−T₁=P₁” is formed. For the driven pulley 102, a formula of “T₂−T₃=P₂” is formed. For the driven pulley 103, a formula of “T₃−T₄=P₃” is formed. The same formulas are formed for the all of the “N” number of pulleys. For the “N”-th pulley, a formula of “T_{N}−T₁=P_{N}” is formed. When the above formulas are lined up, the following formula (27) is obtained.
Formula (27):

$$\begin{matrix}{T}_{2} - {T}_{1} = {P}_{1} \\ {T}_{2} - {T}_{3} = {P}_{2} \\ {T}_{3} - {T}_{4} = {P}_{3} \\ … \\ {T}_{N} - {T}_{1} = {P}_{N}\end{matrix} \} \qquad ( 27 )$$

When considering that the driving force “P₁” at the driving pulley 101 is obtained by a formula of “P₁=P₂+P₃+ . . . P_{N}” the formula of the first line in the above formula (27) is obtained by respectively adding the left sections and the right sections. Therefore, the formula (27) does actually have “N-1” numbers of formulas. Since the unknown values are “N” numbers, one more formula is necessary to decide the tensile forces. Two cases are considered, namely a case in which the auto-tensioning pulley is not provided in the belt transmission system, and another case in which the auto-tensioning pulley is provided, to decide the above additional formula.

(Analysis for the System Having no Auto-Tensioning Pulley)

An elongation “ΔL₀” of the belt, when an initial tensile force “T₀” is applied, can be obtained by the following formula (28), wherein a spring constant is “kₙ”.
Formula (28)

$$Δ {L}_{0} = \frac{{T}_{0}}{{k}_{1}} + \frac{{T}_{0}}{{k}_{2}} + … + \frac{{T}_{0}}{{k}_{N}} \qquad ( 28 )$$

An elongation “ΔL” of the belt, when the belt transmission system is in its operation, can be likewise obtained by the following formula (29).
Formula (29):

$$Δ L = \frac{{T}_{1}}{{k}_{1}} + \frac{{T}_{2}}{{k}_{2}} + … + \frac{{T}_{N}}{{k}_{N}} \qquad ( 29 )$$

A relative elongation “ΔL−ΔL₀”, which is an elongation of the belt caused by a change from the initial state to the operational state, can be obtained by the following formula (30).
Formula (30):

$$Δ L - Δ {L}_{0} = \frac{{T}_{1} - {T}_{0}}{{k}_{1}} + \frac{{T}_{2} - {T}_{0}}{{k}_{2}} + … + \frac{{T}_{N} - {T}_{0}}{{k}_{N}} \qquad ( 30 )$$

In the case that a cross sectional area of the belt is “A” and a Young's modulus is “E”, a formula “Kₙ=AE/Lₙ” is formed And thereby, the following formula (31) can be obtained.
Formula (31)

$$Δ L - Δ {L}_{0} = \frac{{L}_{1} ( {T}_{1} - {T}_{0} ) + {L}_{2} ( {T}_{2} - {T}_{0} ) + … + {L}_{N} ( {T}_{N} - {T}_{0} )}{AE} \qquad ( 31 )$$

Since the relative elongation “ΔL−ΔL₀” is actually zero, the above formula is cleaned up and transformed to the following formula (32).
Formula (30):

$${L}_{1} {T}_{1} + {L}_{2} {T}_{2} + … + {L}_{N} {T}_{N} = {T}_{0} {\sum }_{n = 1}^{N} {L}_{n} \qquad ( 32 )$$

Since “N” numbers of the equations are given by the above formulas (27) and (32), the tensile forces “T₁, T₂ . . . T_{N}” of “N” numbers can be obtained. Since the above formulas are “N”-dimensional simultaneous linear equations, those formulas can be easily solved. The matrix calculation, for example, can be applied. The detailed solving process is omitted here. As above, all of the tensile forces can be calculated. In the case that the system has two pulleys, “N” is “2”, and thereby the formula (32) becomes equal to the formula (13).

(Analysis for the System Having an Auto-Tensioning Pulley)

A relative elongation of the belt is obtained by the following formula (33), as in the same manner to the formula (31), wherein a load by the auto-tensioning pulley at the initial state is “Tₜ”, an elongation of the belt at the initial state is “ΔLₜ”, and an elongation of the belt during the belt operation is “ΔL”.
Formula (33):

$$Δ L - Δ {L}_{t} = \frac{\begin{matrix}{L}_{1} ( {T}_{1} - {T}_{1} ) + … + {L}_{n} ( {T}_{n} - {T}_{t} ) + \\ {L}_{n + 1} ( {T}_{n + 1} - {T}_{t} ) + … + {L}_{N} ( {T}_{N} - {T}_{t} )\end{matrix}}{AE} \qquad ( 33 )$$

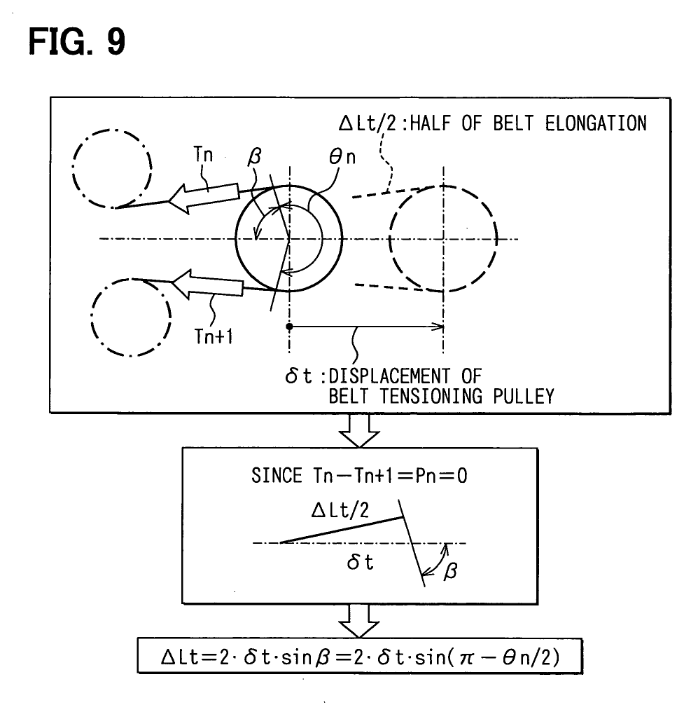

As shown in FIG. 9, when the “n”-th pulley is regarded as the belt-tensioning pulley, the elongation of the belt is absorbed by a displacement “δₜ” of the belt-tensioning pulley. When a spring constant of the belt-tensioning pulley is “K”, a formula of “Tₙ=Tₙ₊₁=Tₜ” is formed at the initial state. Then, the following formula (34) is obtained. During the system is in operation, the following formulas (35) or (36) can be obtained. As a result, the following formula (37) is obtained.
Formula (34):

$$Δ {L}_{t} = 2 {δ}_{t} sin ( π - \frac{{θ}_{n}}{2} ) = \frac{2 {T}_{t}}{K} {sin}^{2} ( π - \frac{{θ}_{n}}{2} ) \qquad ( 34 )$$

Formula (35):

$$\frac{Δ L}{2} = {δ}_{t} sin ( π - \frac{{θ}_{n}}{2} ) = \frac{{T}_{n}}{K} {sin}^{2} ( π - \frac{{θ}_{n}}{2} ) \qquad ( 35 )$$

Formula ( 36):

$$\frac{Δ L}{2} = \frac{{T}_{n + 1}}{K} {sin}^{2} ( π - \frac{{θ}_{n}}{2} ) \qquad ( 36 )$$

Formula (37):

$$\frac{Δ L}{2} = \frac{{T}_{n} + {T}_{n + 1}}{K} {sin}^{2} ( π - \frac{{θ}_{n}}{2} ) \qquad ( 37 )$$

Since the relative elongation of the belt, which is absorbed by the belt-tensioning pulley, is “ΔL−ΔLₜ”, namely “the formula (37) —the formula (34) ”, the following formula (38) is obtained.
Formula (38):

$$Δ L - Δ {L}_{t} = - [ \frac{{T}_{n} + {T}_{n + 1}}{K} - \frac{2 {T}_{1}}{K} ] {sin}^{2} ( π - \frac{{θ}_{n}}{2} ) \qquad ( 38 )$$

Since the belt-tensioning pulley generally absorbs the elongation in a way of reducing the load of the belt, a sign of the beginning of the right section in the formula (38) is made “− (minus)”. This is also applied to the formula (33). In the case that the elongation is absorbed in a way of increasing the load of the belt, the sign must be changed to “+ (plus)”

Since the relative elongation of the belt is equal to that of the belt-tensioning pulley, it becomes “the formula (33)=the formula (38) ”. When the left and right sections of the formulas are cleaned up, the following formula (39) is obtained.
Formula (39):

$${KL}_{1} {T}_{1} + {KL}_{2} {T}_{2} + … + [ {KL}_{n} + AE {sin}^{2} ( π - \frac{{θ}_{n}}{2} ) ] {T}_{n} + [ {KL}_{n + 1 } + AE {sin}^{2} ( π - \frac{{θ}_{n}}{2} ) ] {T}_{n + 1 } + … + \\ {KL}_{N} {T}_{N} = [ K {\sum }_{n + 1}^{N} {L}_{n} + 2 AE {sin}^{2} ( π - \frac{{θ}_{n}}{2} ) ] {T}_{t} \qquad ( 39 )$$

Since “N” numbers of the equations are given by the above formulas (27) and (39), all of the tensile forces can be decided.

For example, the spring constant “K” is zero “0 (zero)”, the formula (39) is transformed to “Tₙ+Tₙ₊₁=2Tₜ”. And when the formula “Tₙ+Tₙ₊₁=Pₙ=0” from the related equation of the formula (27) is taken into consideration, then it becomes “Tₙ=Tₙ₊₁=Tₜ”.

As explained in the above two cases, when an alignment of the pulleys is decided, the tensile forces between the pulleys at the initial state and in the belt operation can be primarily decided by the relation between the pulleys and the belt. Namely, the tensile forces can be decided only by the macroscopic alignment, without needing the microscopic information, such as the respective contact angles, diameters, kinds of the belt, number of the belts, and so on.

Then the respective pulleys are analyzed based on the above results.

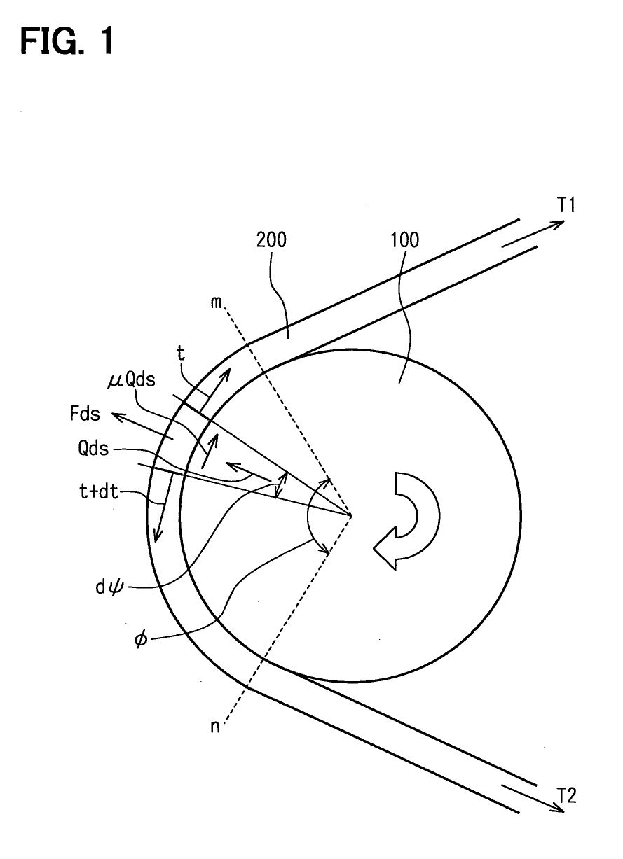

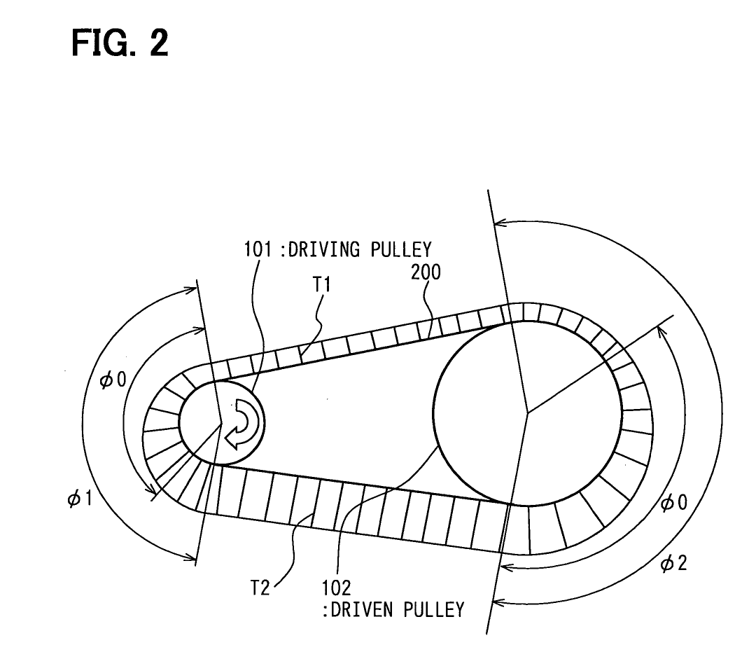

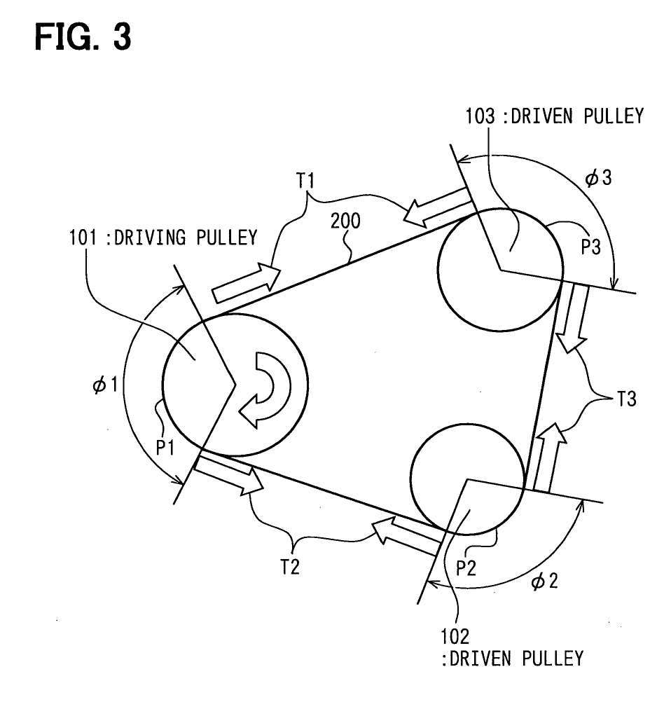

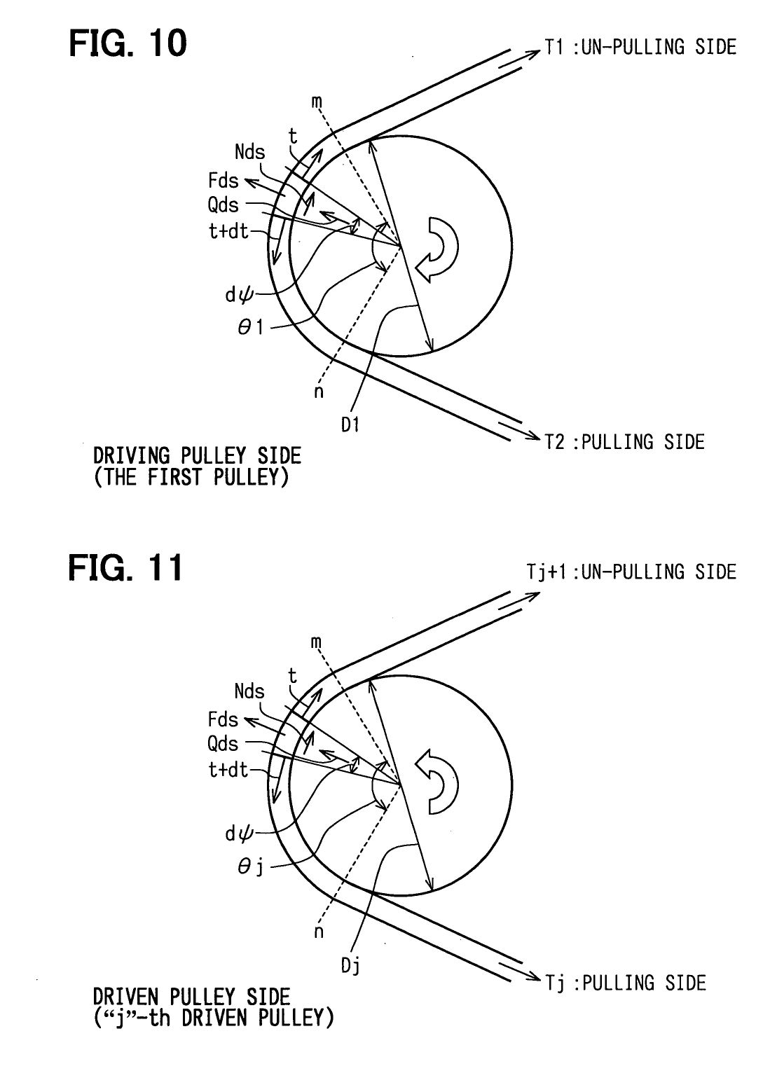

The case of the driving pulley 101, in which the belt is driven without slip, is explained with reference to FIG. 10. In FIG. 10, the frictional force and the contact angle are respectively changed to “N_{ds}” and “θ₁”, when compared with those of FIG. 1.

An equilibrium equation in a radial direction is obtained from the following formula (40), by eliminating micro sections. A formula (42) is obtained by substituting the formula (40) in a formula (41).
Formula (40):

$$Qds = ( t - \frac{{wv}^{2}}{g} ) d φ \qquad ( 40 )$$

Formula (41):

$$ds = \frac{{D}_{1} d φ}{2} \qquad ( 41 )$$

Formula (42):

$$Q = \frac{2 ( t - \frac{{wv}^{2}}{g} )}{{D}_{1}} \qquad ( 42 )$$

An equilibrium equation in a circumferential direction is obtained from the following formula (43), by eliminating micro sections. Since the driving force “P₁” from the pulley is transmitted to the belt by the frictional force “N_{ds}” at the whole contacting area between the pulley and the belt, the driving force “P₁” is represented by the following formula (44). When the formula (43) is substituted in the formula (44), the formula (45) is obtained. The formula (45) becomes equal to the first equation of the formula (27). This shows that the result macroscopically obtained satisfies automatically the values obtained for the individual pulleys, and there is no contradiction therebetween. Further, when the division of the formula (43) is done by the formula (40), the following formula (46) is obtained.
Formula (43):
Nds=dt (43)
Formula (44):

$${P}_{1} = {\int }_{m}^{n} N ⅆ s \qquad ( 44 )$$

Formula (45):

$${P}_{1} = {\int }_{{T}_{1}}^{{T}_{2}} ⅆ t = {T}_{2} - {T}_{1} \qquad ( 45 )$$

Formula (46):

$$\frac{N}{Q} = \frac{ⅆ t}{( t - \frac{{wv}^{2}}{g} ) ⅆ φ} \qquad ( 46 )$$

In the above formula (46), the ratio of “N” and “Q” in the left section is a ratio between a force in a tangential line and a force in a perpendicular direction, namely it is so called the coefficient of static friction. This is not the maximum coefficient of static friction. In some of literatures, the maximum coefficient of the static friction is simply referred to the coefficient of the static friction. In order to avoid any misunderstanding or confusion, the ratio of “N” and “Q” is designated by “η₁”. Namely, ”η₁” is defined as in the following formula (47).

When the coefficient of the static friction is designated by “η₁”, a formula (48) can be obtained. A formula (49) is further obtained by cleaning up the formula (48).
Formula (47):

$${η}_{1} = \frac{Force in Tangential Line ( Frictional Force )}{Perpendicular Force} = \frac{N}{Q} \qquad ( 47 )$$

Formula (48):

$${η}_{1} = \frac{ⅆ t}{( t - \frac{{wv}^{2}}{g} ) ⅆ φ} \qquad ( 48 )$$

Formula (49):

$${η}_{1} \cdot d φ = \frac{dt}{( t - \frac{{wv}^{2}}{g} )} \qquad ( 49 )$$

Here, when it is assumed that “η₁” is constant from a point “m” to a point “n”, it is equal to that an average value between the points “m” and “n” is “η₁”. When the both sections of the formula (49) are integrated, a formula (50) is obtained. A formula (51) is obtained by cleaning up the formula (50) after the integration.
Formula (50):

$${η}_{1} {\int }_{0}^{{θ}_{1}} ⅆ φ = {\int }_{{T}_{1}}^{{T}_{2}} \frac{ⅆ t}{( t - \frac{{wv}^{2}}{g} )} \qquad ( 50 )$$

Formula (51):

$${η}_{1} = \frac{1}{{θ}_{1}} ln \frac{{T}_{2} - \frac{{wv}^{2}}{g}}{{T}_{1} - \frac{{wv}^{2}}{g}} \qquad ( 51 )$$

It is necessary to satisfy a formula (52), when the belt is to be operated without slip, and a formula (53) is obtained, wherein the maximum coefficient of the static friction is designated by “μₘₐₓ”.

Formula (52):
μₘₐₓQds≧Nds (52)
Formula (53):

$${μ}_{max} \geq \frac{N}{Q} = {η}_{1} \qquad ( 53 )$$

Namely, a slip determination formula (54) is obtained, wherein the formula indicates that the slip does not occur so long as the values “η” calculated by the formula (51) satisfies the formula (54). As the above method is different from the Euler's analysis, the value of “η₁” can be calculated, because the tensile forces are known values.

Formula (54):
μₘₐₓ≧η₁ (54)

The case of the “j”-th driven pulley, in which the pulley is driven without slip, is explained with reference to FIG. 11. In FIG. 11, only a rotational direction is different from that of FIG. 10, when compared with those of FIG. 10. The drawing of dynamics of FIG. 11 is identical to that of FIG. 10, from its appearance. However, it is different in that the pulley is driven by a difference of the tensile forces “Tⱼ−Tⱼ₊₁=Pⱼ” with the frictional force “N_{ds}”. This is a different point in that the pulley is driven by the belt on one hand, and the belt is driven by the pulley on the other hand.

The formulas identical to the formulas (40), (42) and (43) are formed. A formula (55) is obtained, by integrating from a point “m” to a point “n”. A formula (56) similar to the formula (51) is obtained from the formula (55) through the same process for the formula (50). A slip determination formula is obtained as a formula (57).
Formula (55):

$${η}_{j} {\int }_{0}^{{θ}_{j}} ⅆ φ = {\int }_{{T}_{j + 1}}^{{T}_{j}} \frac{ⅆ t}{( t - \frac{w {v}^{2}}{g} )} \qquad ( 55 )$$

Formula (56):

$${η}_{j} = \frac{1}{{θ}_{j}} ln \frac{{T}_{j} - \frac{w {v}^{2}}{g}}{{T}_{j + 1} - \frac{w {v}^{2}}{g}} \qquad ( 56 )$$

Formula (57):
μₘₐₓηⱼ (57)

As shown in FIG. 8, in which the driving pulley and the driven pulleys are shown, when the above results are cleaned up by simply differentiating the numbers of the pulleys (without differentiating by the driving or driven pulleys), the following formula (58) is obtained for the “n-th pulley. This formula (58) is applied to the driven pulley. When the formula (58) is applied to the driving pulley, the numbers of the suffix for the tensile force at the pulling side and the tensile force at the un-pulling side in the formula (58) is reversed. Namely, the tensile force at the pulling side is “T ₙ₊₁”, whereas the tensile force at the un-pulling side is “Tₙ”. Therefore, in the case of the driving pulley 101, since “n” is “1”, the tensile force of the pulling side is “T₂”, whereas the tensile force at the un-pulling side is “T₁”.

In the case that the centrifugal force can be neglected, a formula (59) is formed. A force in the perpendicular direction for the belt of the unit length, namely the perpendicular force “Qₙ” is given by a formula (60). A frictional force of the belt of the unit length “Nₙ” is given by a formula (61).
Formula (58):

$${η}_{n} = \frac{1}{{θ}_{n}} ln \frac{Tensile Force at Pulling Side {T}_{n} - \frac{w {v}^{2}}{g}}{Tensile Force at Un \text{-} Pulling Side {T}_{n + 1} - \frac{w {v}^{2}}{g}} \qquad ( 58 )$$

Formula (59):

$${η}_{n} = \frac{1}{{θ}_{n}} ln \frac{Tensile Force at Pulling Side {T}_{n}}{Tensile Force at Un \text{-} Pulling Side {T}_{n + 1}} \qquad ( 59 )$$

Formula (60):

$${Q}_{n} = \frac{2 ( t - \frac{w {v}^{2}}{g} )}{{D}_{n}} \qquad ( 60 )$$

Formula (61):
NₙηₙQₙ (61)

As above, since the macroscopic analysis and the calculations for the respective pulleys are solved, the conditions for driving the belt and pulleys in a normal operation without slip can be summarized as follows:

Since a problem, such as short life duration, breakage of the belt or the like, may occur when the maximum tensile force exceeds a permissible tensile force, it is necessary to satisfy the following formula (62). The permissible tensile force is given by, for example, an elastic limit, a fatigue limit, a tensile strength, and so on.

Formula (62):
“T₁, T₂ . . . T_{N}”<allowable tensile force of the belt (62)

And it is also necessary to satisfy the following formula (63), although it is quite natural that the belt is loosened when the tensile force becomes lower than zero. A value of around 100N is generally used as the minimum tensile force for a reliable belt transmission by taking a safety factor into consideration.

Formula (63):
“T₁, T₂ . . . T_{N}”>minimum necessary tensile force of the belt (63)

Furthermore, the conditions for the reliable belt transmission without the slip can be given in the following manner for the respective pulleys. At first, the inside section of the natural logarithmic function of the formula (58) must be “+” (plus), to satisfy the formula (58). Therefore, the following formula (64) must be satisfied. Here, a section for the pulling side becomes automatically “+” (plus), if the formula (64) is satisfied.
Formula (64):

$$Tensile Force at Un \text{-} Pulling Side > \frac{w {v}^{2}}{g} \qquad ( 64 )$$

When the formula (60) would become “−” (minus), it means that the belt would be separated (lifted up) from the pulley. And therefore, the formula (60) must be also “+” (plus). However, since the most severe condition is “t=tensile force at the un-pulling side”, the formula (60) becomes identical to the formula (64).

The following formula (65) must be satisfied, so that no slip may occur.

Formula (65):
μₘₐₓ≧ηₙ (65)

Furthermore, it is preferable to avoid a resonance, although it is not an absolute condition. It is preferable to avoid that a resonant frequency of the belt coincides with a cycle of explosion in an engine. The cycle of explosion in case of a 6-cylinder 4-cycle engine is a value of three times of the engine revolution. The parameters must be so designed that a resonant frequency of a primary mode, as shown in the following formula (66), is deviated from the cycle of engine explosion, as much as possible.
Formula (66):

$$Resonant Frequency at Primary Mode = \frac{1}{2 {L}_{n}} \sqrt{\frac{{T}_{n} g}{w}} \qquad ( 66 )$$

Now, all of the conditions for the normal operation of the belt transmission and the formulas for the tensile forces of the belt are made clear.

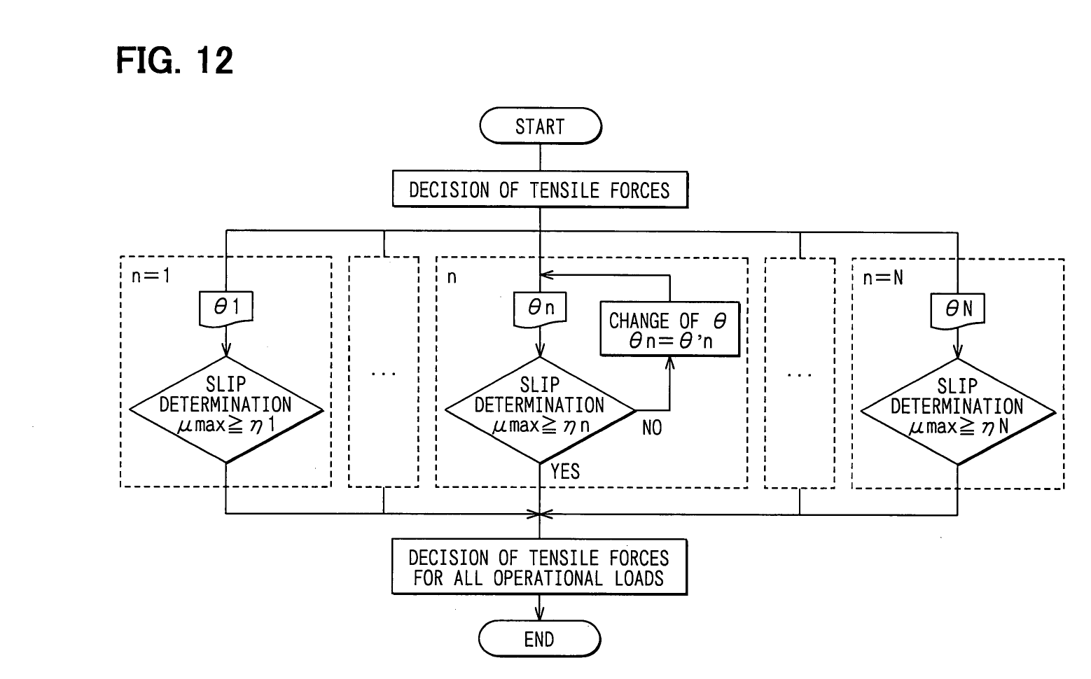

FIG. 12 shows again the process of the design method according to the present invention. The tensile forces among all of the pulleys are decided at first, irrespectively of the contact angles in the respective pulleys. And thereby, the slip determination for the respective pulleys can be performed in the post-process. Even in the case that the slip is determined in a certain pulley, it is sufficient to take an action, such as a change of the contact angle, by only one time for such specific pulley, so that the slip determination for the pulley can be made to a “good” situation. Furthermore, there is no influence on the other pulleys due to the change of the contact angle. Accordingly, the design method for the belt transmission system of the present invention is superior in that it is simple and the tensile forces in all operating load conditions can be calculated.

In FIG. 12, although unit processes, each having a step of deciding the contact angle “θ” (“θ₁”, “θ₂” . . . “θₙ”) and a step for the slip determination, are shown in parallel, they can be sequentially performed. For example, those processes in FIG. 12 can be performed by a design assisting system of a computer. The design assisting system comprises multiple blocks of an input device, a calculating device, and a display device. The calculating portions of the design method for the belt transmission system are performed by the calculating device. In this case, the unit processes are performed in a sequential order. A process for changing the conditions of the pulley can be provided at an end of the respective unit processes, or at the end of the entire unit processes. For example, a process for changing parameters of a pulley layout for such pulley, which is determined as “defective”, can be added, while keeping the parameters of other pulleys, which are determined as “good”. In this case, a display device is provided for displaying the pulley, which is determined as “defective”, and the design parameters for the pulley are changed in accordance with the inputted information by an operator, and the slip determination is performed again. Furthermore, such a step can be added, in which a changeable dimension for the design parameters is displayed in relation to the pulley, which is determined as “defective”, and the desired design parameters can be selected by the operator or the desired design parameters can be set by the operator.

In the case of an extremely large (practically impossible) load, the life duration of the belt can be prolonged on the contrary, if the slip is intentionally generated at the belt. For example, it is the case, that the belt tension is reduced as a whole for such an operation of a low load, when the most of the cases are operated with the low load. Even in such a case, in which the slip may occur, the tensile forces can be calculated according to the design method for the belt transmission system of the present invention.

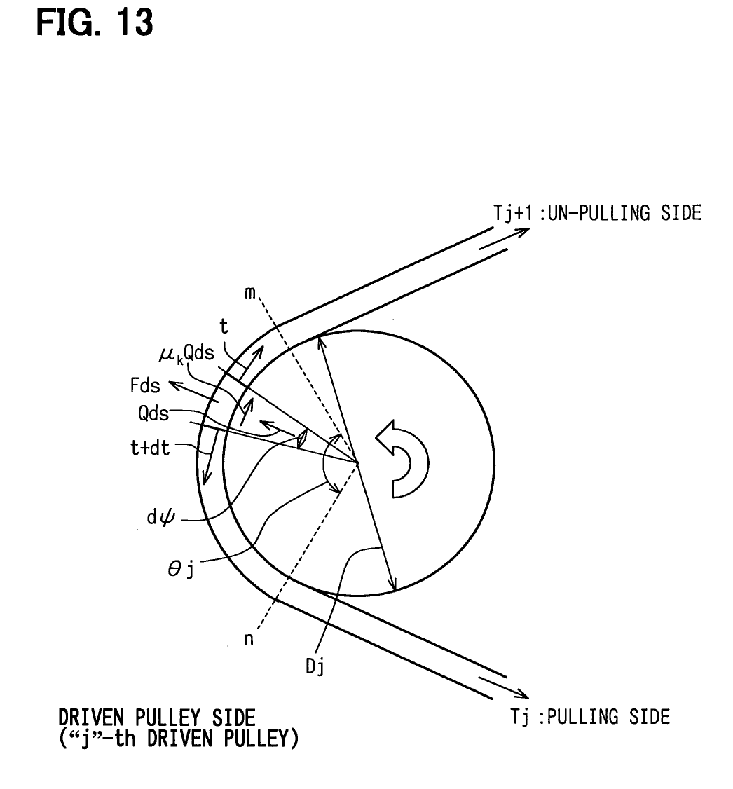

An explanation is made hereunder for a case, for example, in which a slip is occurring at the “j”-th driven pulley, namely the following formula (67) is realized. Dynamics of this case is shown in a model of FIG. 13, wherein coefficient of dynamic friction is “μₖ”. FIG. 13 differs from FIG. 11 in that the frictional force is replaced by “μₖ Q_{ds}”. When the equilibrium equations in the radial and circumferential directions are cleaned up, the following formula (68) is obtained. The difference between the formulas (7) and (68) is that the coefficient of the friction of the formula (7) is the coefficient of the static friction, while the coefficient of the friction of the formula (68) is the coefficient of the dynamic friction.

Formula (67):
μₘₐₓ≦ηⱼ (67)
Formula (68):

$$\frac{{T}_{j} - \frac{w {v}^{2}}{g}}{{T}_{j + 1} - \frac{w {v}^{2}}{g}} = {ⅇ}^{{μ}_{k} {θ}_{j}} \qquad ( 68 )$$

In the case that the slip is occurring, the equation in the formula (27) corresponding to the “j-th pulley is not realized Namely, it becomes “Tⱼ−Tⱼ₊₁≠Pⱼ”. As a result, one equation comes short for the tensile forces of “N” numbers of unknown values. Then, the formula (68) is used as the alternative for such equation coming short, to obtain “N”-dimensional simultaneous equations so that all of the tensile forces can be calculated.

In this case, the actual driving force “Pⱼₛₗᵢₚ” at the “j”-th pulley is “Pⱼₛₗᵢₚ=Tⱼ−Tⱼ₊₁”. The above actual driving force “Pⱼₛₗᵢₚ” becomes smaller, by “Pⱼ−Pⱼₛₗᵢₚ”, than the driving force “Pⱼ” necessary for the load. Accordingly, the design method of the present invention further has a superior effect in that an amount of the slip can be also estimated.

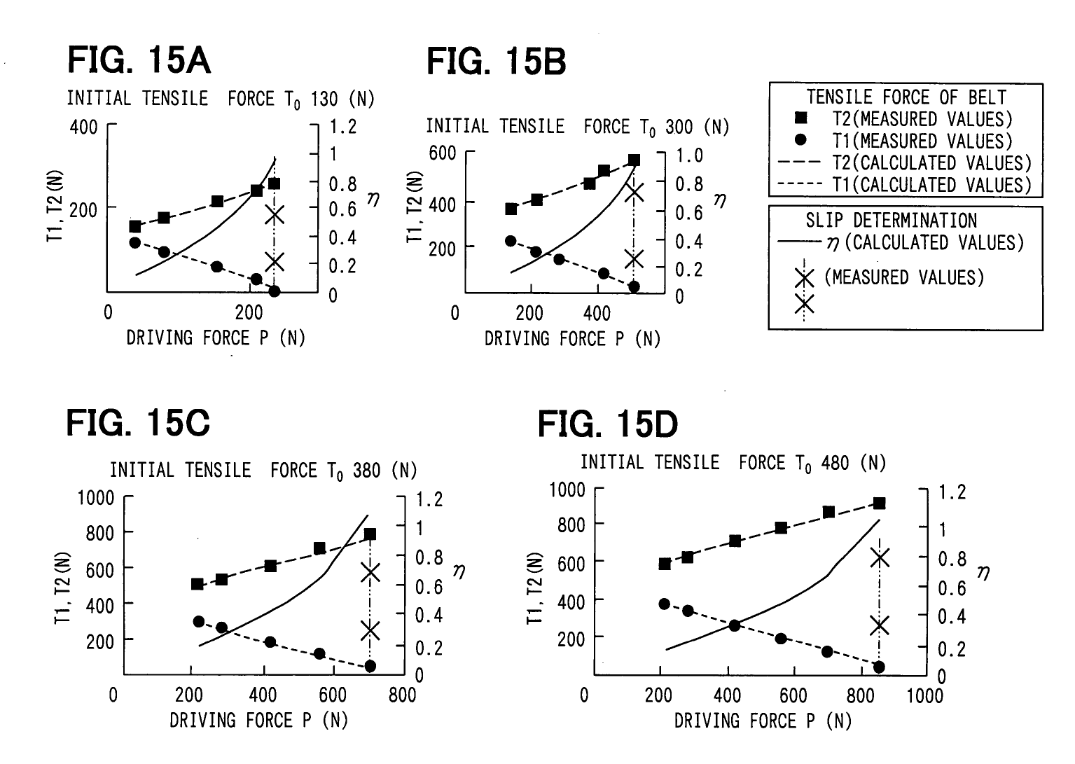

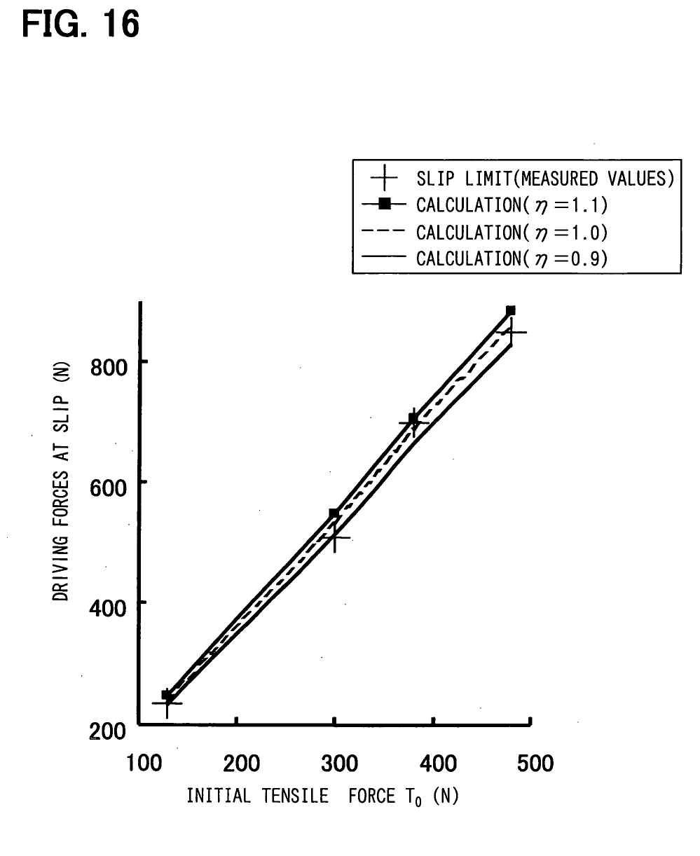

FIGS. 15 and 16 show the tensile forces and the slip determination results, both of which are obtained from the calculation method of the present invention and actual measurements, wherein the belt transmission system comprises two pulleys.

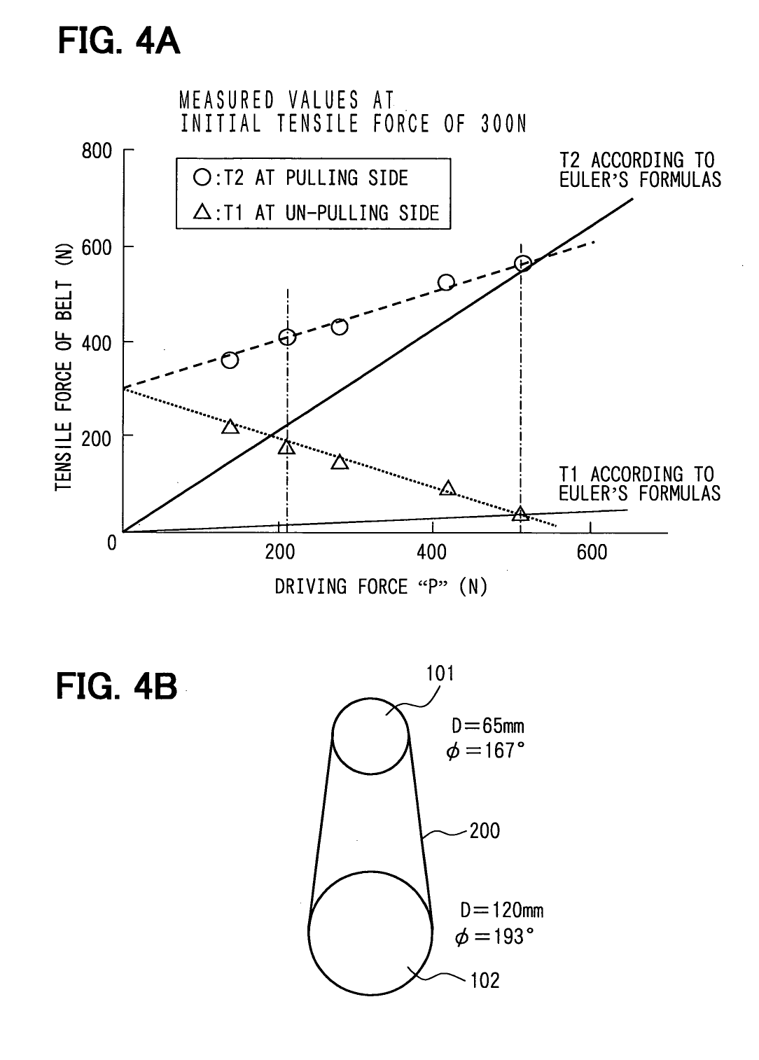

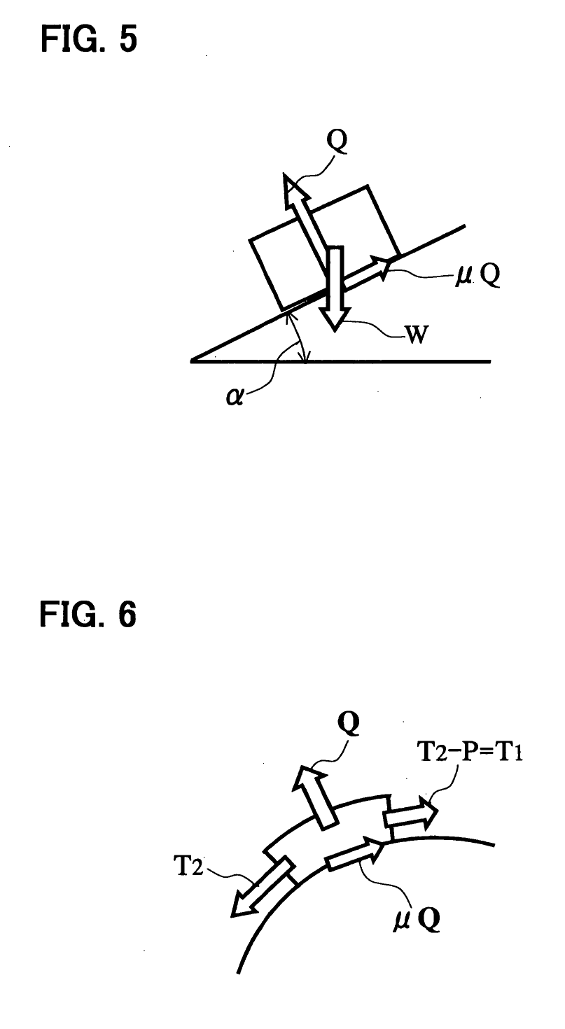

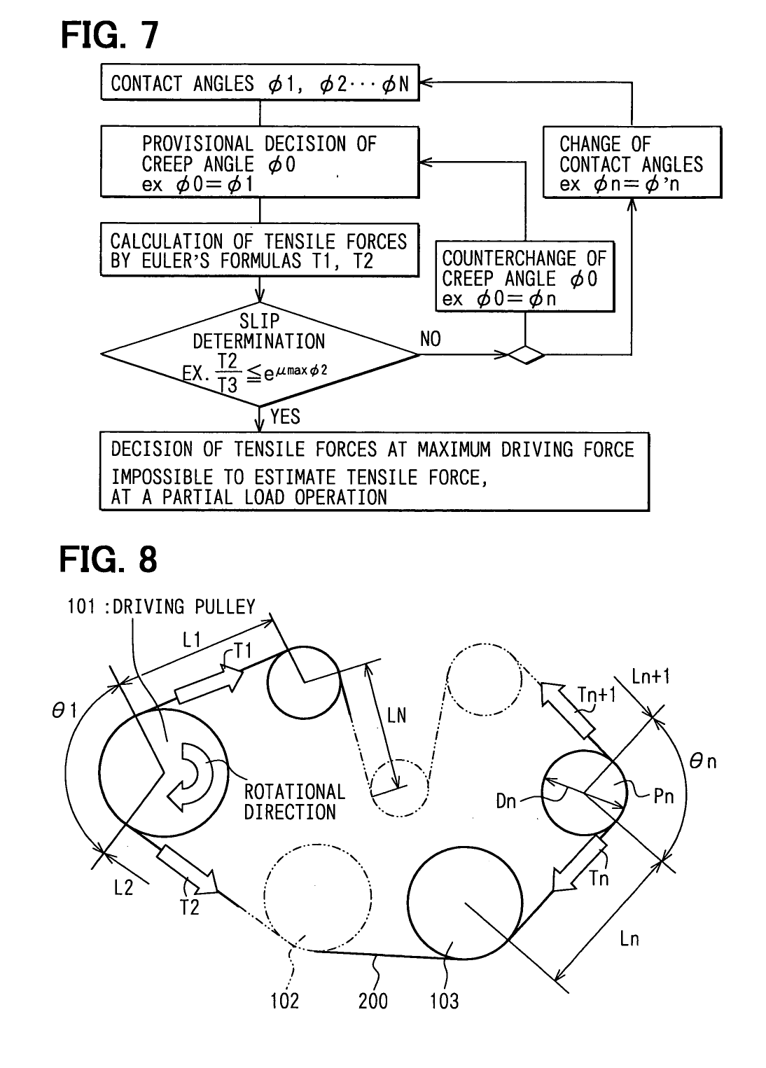

FIGS. 15A to 15D are graphs for the tensile forces and “η” with respect to the driving force, wherein the initial tensile force “T₀” is varied. The other experimental conditions are the same to that of FIG. 4. The calculated tensile forces “T₂” and “T₁” of the pulling and the un-pulling sides coincide with the experimental results, even when the driving force “P” is varied. It is understood that the value “η” is increased in accordance with an increase of the driving force “P”, and finally the slip occurs when the driving force exceeds a certain value. In the graphs, a symbol “X” shows a point, at which the slip occurred. The slip measurement has been done in such a way that the same points of the belt and pulley are marked and the slip was determined when one of the marks is relatively displaced from the other mark. A visual observation can be possible, since the determination is done when the belt and pulley are not rotated.

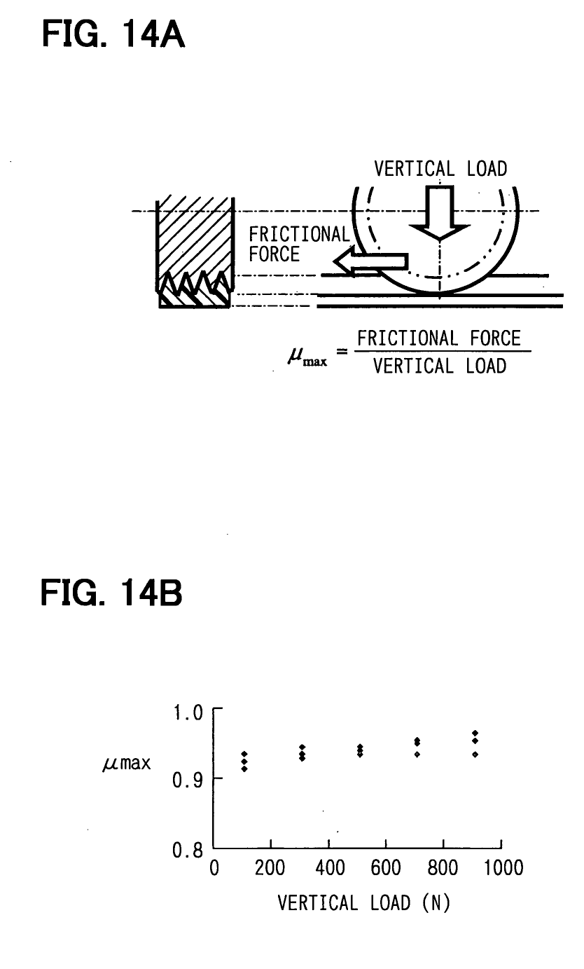

FIG. 16 is a graph, in which the above driving forces at the slips are shown with respect to the initial tensile forces. It is understood that the slip occurs more hardly at the larger driving force when the initial tensile force “T₀” is increased. A relationship between the initial tensile force “T₀” and the driving force “P” is also shown in FIG. 16, wherein the value “η” is varied. The values “η” are calculated by the formula (58), wherein the “T₁” and “T₂” obtained from the driving force “P” and the initial tensile force “T₀” are substituted. This means, in other words, that it shows “η” necessary for transmitting the given driving force “P”. According to this process, the calculated values and the actually measured values for the driving forces at the slips coincide with each other when the value of “η” is between 0.9 and 1.0. This fact also coincides with the experimental result shown in FIG. 14B, wherein the maximum coefficients of the static friction are plotted between 0.9 and 1.0. The above facts also show that the slip determination according to the present invention is correct. FIG. 14B shows the maximum coefficients “μₘₐₓ”, which are calculated from a ratio of a vertical load and a frictional force. FIG. 14A shows a model for measuring the maximum coefficients, wherein a pulley is pressed against a V-ribbed belt, and frictional forces, at a point at which a slip occurs, are measured by varying the vertical load.

According to the design method for the belt transmission system of the present invention, it has superior advantages in that the tensile forces can be correctly simulated (such simulation was not possible in the prior art), the slip determination can be simply and easily done, and repeated calculation is not necessary. Furthermore, it becomes possible to determine the slip limit (at which the slip may occur) with respect to the variation of the initial tensile forces, which was not clarified in the prior art. Namely, in the prior art, as explained already above, the determination of using the value of “μₘₐₓ” and the creep angle “φ₀”, which in fact cannot be obtained, or the determination of using “P/φ”, “P/(φ·a pulley radius)”, which are unclear in physical basis, were done.

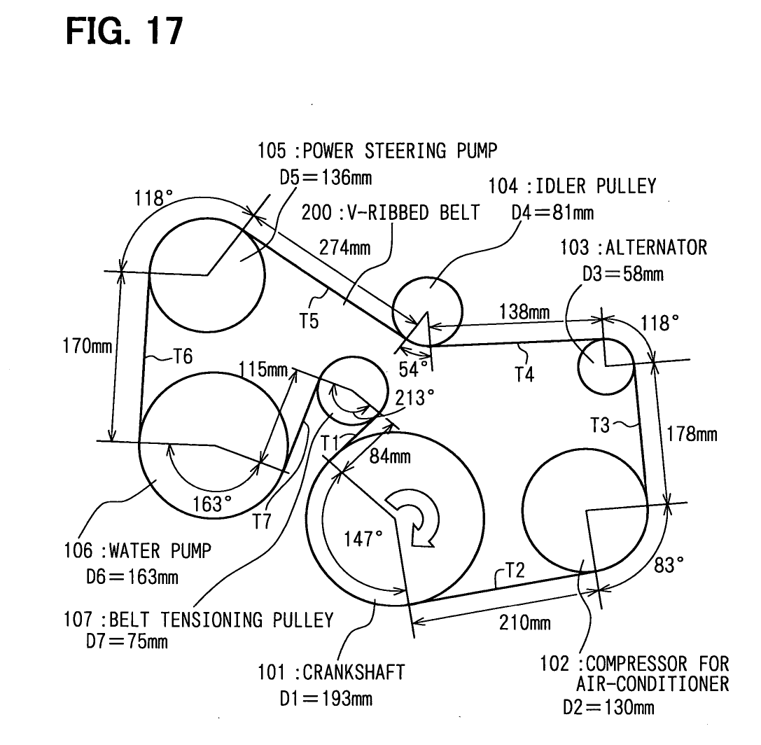

The design method (the slip determination method) for the belt transmission system of the present invention is further explained with reference to an example, in which the design method is applied to the engine. FIG. 17 shows an example showing the belt transmission system of the serpentine type, to which the present invention is applied. The reference numerals are used in FIG. 17, corresponding to that in FIG. 8. The driving pulley 101 is connected to a crankshaft of the engine. The driven pulley 102 is connected to a compressor for an air conditioning apparatus. The driven pulley 103 is connected to an alternator. The driven pulley 104 is the idler pulley. The driven pulley 105 is connected to a pump for a power steering apparatus. The driven pulley 106 is connected to a water pump for circulating engine cooling water for the engine. The driven pulley 107 is connected to the auto-tensioning device. The belt 200 is a V-ribbed belt having 6 ribs.

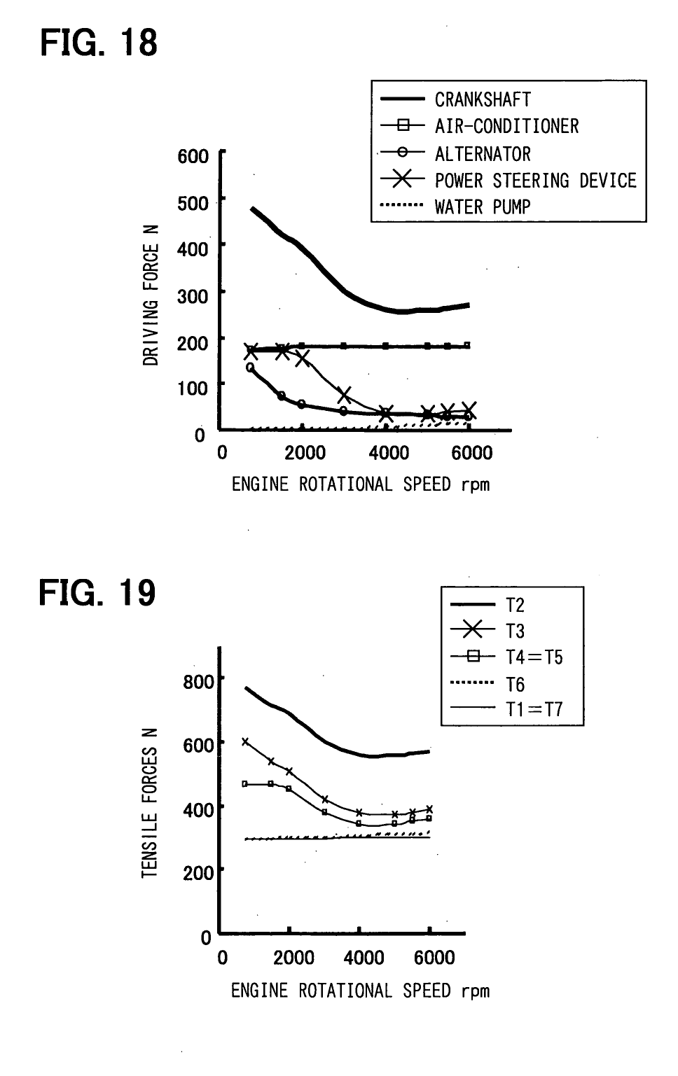

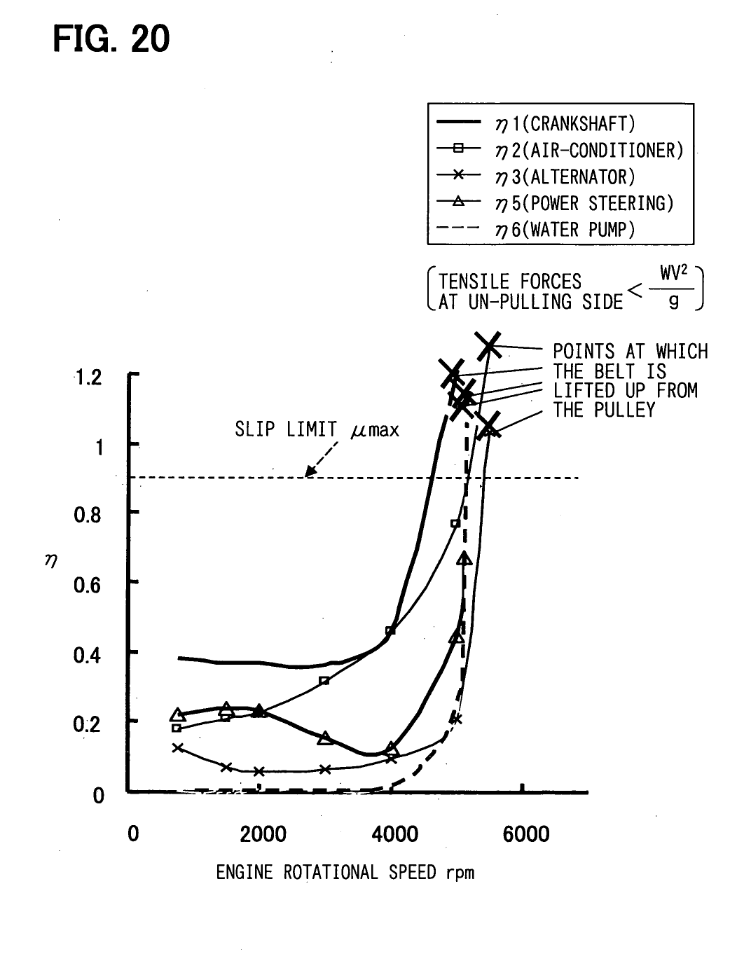

In FIG. 17, the names of the respective accessory devices, which are loads for the pulleys, are indicated. The driving forces “P” for the respective pulleys are varied with respect to the rotational speed of the engine, as shown in FIG. 18. The tensile forces at the respective belts, which are calculated from the formulas (27) and (39) in the case that the load by the auto-tensioning device is set at 300N, are shown in FIG. 19. FIG. 20 shows “η” with respect to the rotational speed of the engine, and it is understood from FIG. 20, that the slip occurs around 5000 rpm, at which the value “η” becomes larger than the slip limit of “μₘₐₓ”. In this embodiment, it is set at “μₘₐₓ=0.9”. Although it is not the case in this embodiment, it was “μₘₐₓ=0.4” according to the actual measurements, in the case that the back surface of the V-ribbed belt is used in the belt transmission system, because the belt does not bite into V-grooves of the pulley. When the rotational speed is further increased, the belt is lifted up from the pulley due to the centrifugal force, according to the conditions of the formula (64), and thereby the belt transmission becomes completely impossible.

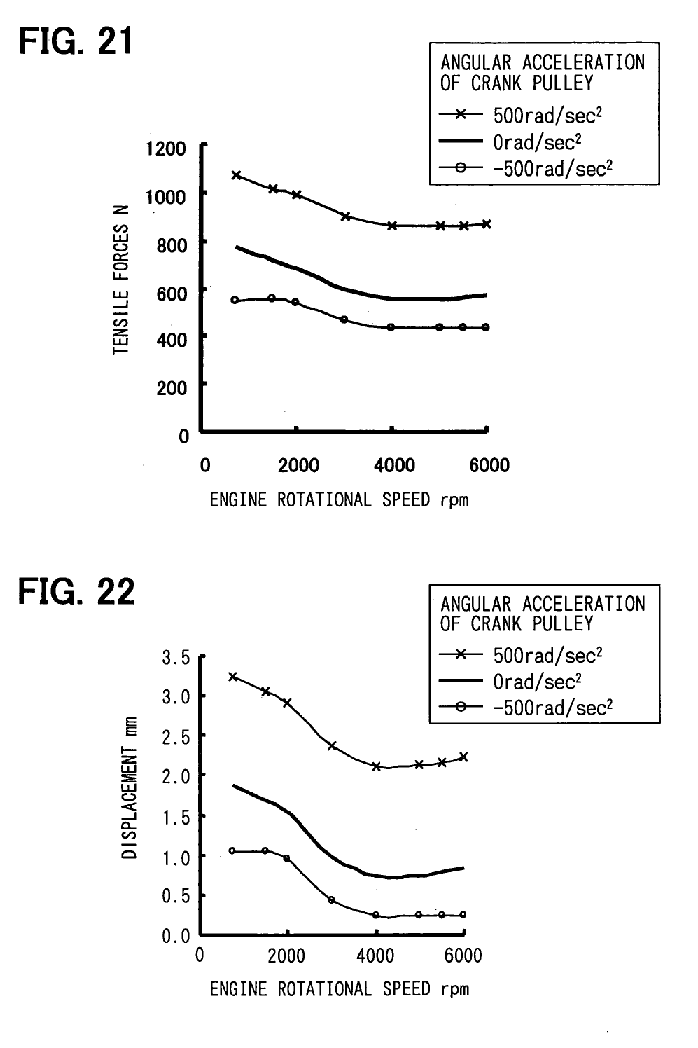

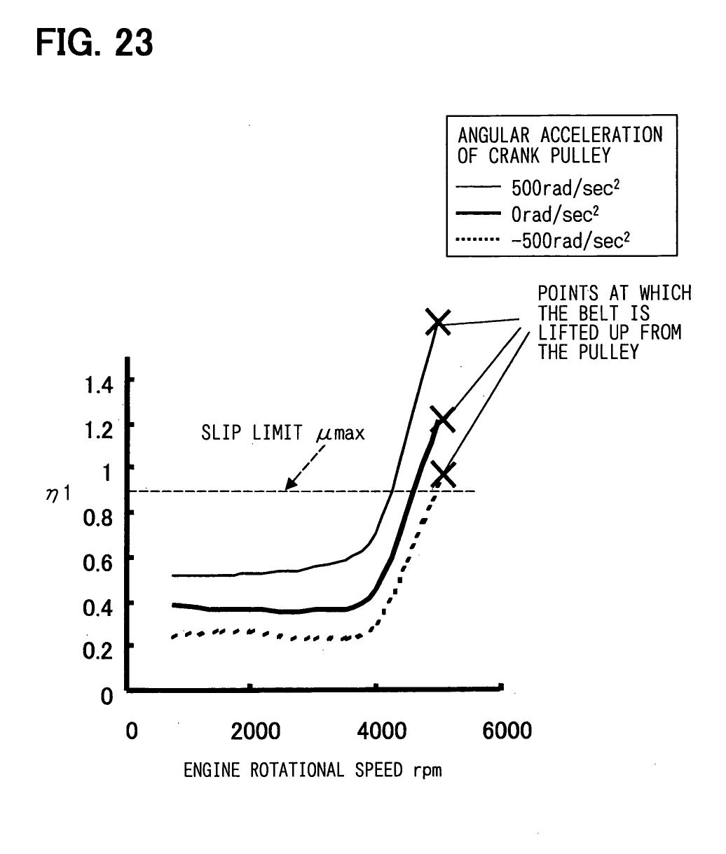

It is further possible according to the present invention that the tensile forces can be calculated even when the rotational speed of the engine is varied. In this embodiment, the crank pulley of the engine is the driving pulley. The tensile forces are shown in FIG. 21, wherein the rotational speed of the driving pulley is varied with an angular acceleration of ±500 rad/sec². The calculation for the tensile forces can be done in the same manner as above, when a value, which is calculated by adding the inertia load obtained from a moment of inertia and an acceleration to a static driving force, is regarded as the driving force. FIG. 21 shows the variation of the tensile forces “T₂” at the pulling side of the crank pulley. FIG. 22 shows variations of the displacement of the auto-tensioning device in the case of “K=3000 N/m”. FIG. 23 shows the values of “η” of the crank pulley. In this example, the operation of the belt transmission system becomes practically impossible, when the rotational speed of the engine is increased to a high amount. However, when the load by the auto-tensioning device is changed to 500N, the allowable range is correspondingly increased. In such a case, although the tensile forces at the respective points are increased by “200 N” in average, such a change is possible, since the tensile force at the respective points is still less than the permissible tensile force of “1400 N”.

The design method for the belt transmission system according to the present invention has a superior effect that the study and calculation for the belt design can be simply and easily done, even when the belt transmission system is of the complex serpentine type, and the loads are changed with time. (The details for the calculation of the tensile forces in the transient response will be explained below.) Even in the case that the calculated values become out of the permissible range at the respective determination processes, the parameters for the pulley layout can be individually changed without affecting to the entire design. As a result, the solutions totally satisfying all of the pulleys can be easily obtained. Furthermore, the design method of the present invention has an advantage in that the transmitting amount of the driving force can be obtained by calculating “Pⱼ−Pⱼₛₗᵢₚ”, even when the slip occurs. The determinations in the design process include the determination of the slip, the determination of the permissible tensile forces, and so on. Further, the parameters of the pulley layout include the pulley diameter, the contact angle between the belt and pulley, the initial tensile force of the belt, the distance between the pulleys, and so on.

Now, the explanation is made for the calculation of the tensile forces during the transient response, in which the loads are varied with time. In this explanation, the pulley layout which is identical to that of FIG. 8 is considered. Rotational angles and moments of inertia at each pulley are respectively designated by “β₁, β₂ . . . β_{N}” and “J₁, J₂ . . . J_{N}”. The driving torque of the engine is designated by “M”. The unknown values are “β₁, β₂ . . . β_{N}” and “T₁, T₂ . . . T_{N}”, the number of which is “2N”.

The dynamic equation of the belt transmission system is given by the following formula (69).
Formula (69):

$$\begin{matrix}{J}_{1} {\ddot{β}}_{1} = M - ( {T}_{2} - {T}_{1} ) \frac{{D}_{1}}{2} \\ {J}_{2} {\ddot{β}}_{2} = ( {T}_{2} - {T}_{3} - {P}_{2} ) \frac{{D}_{2}}{2} \\ {J}_{3} {\ddot{β}}_{3} = ( {T}_{3} - {T}_{4} - {P}_{3} ) \frac{{D}_{3}}{2} \\ … \\ {J}_{N} {\ddot{β}}_{N} = ( {T}_{N} - {T}_{1} - {P}_{N} ) \frac{{D}_{N}}{2}\end{matrix} \} \qquad ( 69 )$$

And the relation between the forces and displacement in the case that the belt-tensioning device is not provided is given by the following formula (70).
Formula (70):

$$\begin{matrix}\frac{{T}_{1} - {T}_{0}}{{k}_{1}} = \frac{{L}_{1} ( {T}_{1} - {T}_{0} )}{AE} = \frac{( {β}_{N} {D}_{N} - {β}_{1} {D}_{1} )}{2} \\ \frac{{L}_{2} ( {T}_{2} - {T}_{0} )}{AE} = \frac{( {β}_{1} {D}_{1} - {β}_{2} {D}_{2} )}{2} \\ ⋯ \\ \frac{{L}_{N} ( {T}_{N} - {T}_{0} )}{AE} = \frac{( {β}_{N - 1} {D}_{N - 1} - {β}_{N} {D}_{N} )}{2}\end{matrix} \} \qquad ( 70 )$$

When the left and right sections of the formula (70), having the “N” number of the equations, are respectively added, then it becomes equal to the formula (32). The formula (69) becomes equal to the formula (27), when it is considered that the driving torque of the engine “M” at the steady state becomes to a value of “P₁D₁/2”, and the following formula (71) is realized.

Formula (71):
\ddot{β}₁\ddot{β}₂= . . . =\ddot{β}_{N}=0 (71)

In the case of the belt transmission system having the belt tensioning device, the following formula (72) is given. In this case, the belt tensioning pulley is regarded as the “n”-th pulley.
Formula (72):

$$\begin{matrix}\frac{{L}_{1} ( {T}_{1} - {T}_{t} )}{AE} = \frac{( {β}_{N} {D}_{N} - {β}_{1} {D}_{1} )}{2} \\ \frac{{L}_{2} ( {T}_{2} - {T}_{t} )}{AE} = \frac{( {β}_{1} {D}_{1} - {β}_{2} {D}_{2} )}{2} \\ ⋯ \\ \frac{{L}_{n} ( {T}_{n} - {T}_{t} )}{AE} = \frac{( {β}_{n - 1} {D}_{n - 1} - {β}_{n} {D}_{n} )}{2} + \frac{{T}_{t} - {T}_{n}}{K} {sin}^{2} ( π - \frac{{θ}_{n}}{2} ) \\ \frac{{L}_{n + 1} ( {T}_{n + 1} - {T}_{t} )}{AE} = \frac{( {β}_{n} {D}_{n} - {β}_{n + 1} {D}_{n + 1} )}{2} + \frac{{T}_{t} - {T}_{n + 1}}{K} {sin}^{2} ( π - \frac{{θ}_{n}}{2} ) \\ ⋯ \\ \frac{{L}_{N} ( {T}_{N} - {T}_{1} )}{AE} = \frac{( {β}_{N - 1} {D}_{N - 1} - {β}_{N} {D}_{N} )}{2}\end{matrix} \} \qquad ( 72 )$$

When the left and right sections of the formula (72), having the “N” number of the equations, are respectively added, then it becomes equal to the formula (39).

In the case that the vibration of the belt tensioning device is further taken into consideration, the following formula (73) is given, wherein “m” is a mass of the belt tensioning pulley, and “x” is a displacement of the belt tensioning pulley. Furthermore, in the case of the belt tensioning device of a swinging type, the moment of inertia is converted into a value of the corresponding mass, and substituted for the value “m”. Furthermore, in the case that the viscous damping is taken into consideration, a section for such viscous damping is added in the formula (69).
Formula (73):

$$m \ddot{x} = Kx + ( {T}_{n} + {T}_{n + 1} ) sin ( π - \frac{{θ}_{n}}{2} ) \qquad ( 73 )$$

As explained above, the number of unknown values and number of formulas become equal to each other, so that the tensile forces at the respective pulleys can be calculated. In the case that the system has the belt tensioning device, the formulas (69) and (72) are used, while in the case that the system does not have the belt tensioning device, the formulas (69) and (70) are used.

As a result, the determination of the belt transmission (the slip determination and so on) can be likewise done from the formulas (62) to (66).

1. A design method for a belt transmission system, in which multiple pulleys are driven by a belt, comprising:
a first step of calculating tensile forces “T₁, T₂ . . . T_{N}” between the pulleys from a total layout for the pulleys, the belt and loads of the system, wherein the total layout includes a spring constant of the belt, a distance between the pulleys, an initial tensile force and a driving force to be calculated from respective loads of the pulleys;
a second step of calculating a coefficient “η” of static friction for each of the pulleys, from a tensile force at a pulling side, a tensile force at an un-pulling side and a contact angle calculated by the first step;
a third step of comparing the coefficient of the static friction with a maximum coefficient “μₘₐₓ” of the static friction between the belt and the pulley and determining that a slip does not occur at such a pulley in the case that the following formula (1) of inequality is satisfied for the pulley;
The Formula (1):
the coefficient of the static friction<μₘₐₓ (1)

2. A design method for a belt transmission system according to claim 1, wherein
the coefficient “η” of the static friction is calculated by one of the following formulas (2) and (3), wherein, “w” is a weight of the belt for a unit length, “v” is a speed of the belt, and “g” is an acceleration of gravity;
The Formula (2):
$$η = \frac{1}{Contact Angle θ} ln \frac{( Tensile Force at Pulling Side - \frac{{wv}^{2}}{g} )}{( Tensile Force at Un \text{-} Pulling Side - \frac{{wv}^{2}}{g} )} \qquad ( 2 )$$
The Formula (3):
$$η = \frac{1}{Contact Angle θ} ln \frac{( Tensile Force at Pulling Side )}{( Tensile Force at Un \text{-} Pulling Side )} \qquad ( 3 )$$

3. A design method for a belt transmission system according to claim 1, wherein
the design method is applied to such a belt transmission system of a serpentine type, in which the belt transmission system is operated by an internal combustion engine as a driving source.

4. A design method for a belt transmission system according to claim 3, wherein
the belt transmission system of the serpentine type comprises an idler pulley and a belt tensioning pulley.

5. A design method for a belt transmission system according to claim 1, wherein
a determination is done in accordance with the following formula (4), wherein it is determined that the belt is not lifted up from the pulley when the following formula of inequality is satisfied;
The Formula (4):
$$Tensile Force at Un \text{-} Pulling Side > \frac{{wv}^{2}}{g} \qquad ( 4 )$$

6. A design method for a belt transmission system according to claim 1, wherein
a determination is done in accordance with the following formulas (5) and (6), wherein it is determined that the belt transmission is performed in a safe mode when the following formulas of inequality are satisfied, wherein “T₁, T₂ . . . T_{N}” are the calculated tensile forces between the pulleys;
The Formula (5):
“T₁, T₂ . . . T_{N}”<allowable tensile force of the belt (5)
The Formula (6):
“T₁, T₂ . . . T_{N}”>minimum necessary tensile force of the belt (6)

7. A design method for a belt transmission system according to claim 1, wherein
parameters of pulley layout are changed until the formula (1) is satisfied, wherein the parameters include the contact angle, a pulley diameter, the initial tensile force, and a load by the belt tensioning pulley.

8. A design method for a belt transmission system according to claim 1, further comprising:
a step of calculating a resonant frequency “f” of the belt during its operation, from the calculated tensile forces; and
a step of designing parameters of the pulley layout, the resonant frequency does not coincide with at least one of a frequency of an oscillation caused by a driving source and a natural frequency of the load, wherein the parameters of the pulley layout include the contact angle, a pulley diameter, the initial tensile force, and a load by the belt tensioning pulley.

9. A design method for a belt transmission system according to claim 1, wherein
the load for the respective pulleys, which varies with time, is treated as a driving force, and the design and the determination is done for the belt conditions of the respective time points.

10. A design method for a belt transmission system according to claim 9, wherein
the belt transmission system has a belt tensioning pulley, and
a movement of the belt tensioning pulley is calculated for the respective time points.
